(19) United States
(12) Patent Application Publication
(10) Pub. No.: US 2025/0101311 A1
(43) Pub. Date: Mar. 27, 2025

(54) PROCESS FOR THE PYROLYSIS OF SUBSTANTIALLY PLASTICS MATERIAL OF INCONSTANT COMPOSITION, RELATIVE REACTOR, APPARATUS AND PRODUCT OBTAINED

(71) Applicant: Versalis S.p.A., San Donato Milanese, Milano (IT)

(72) Inventors: Riccardo FELISARI, San Donato Milanese, Milano (IT); Armando GALEOTTI, San Donato Milanese, Milano (IT); Mirco NODARI, San Donato Milanese, Milano (IT); Antonio PONTICIELLO, San Donato Milanese, Milano (IT); Angelo FERRANDO, San Donato Milanese, Milano (IT); Fabio ASSANDRI, San Donato Milanese, Milano (IT)

(73) Assignee: Versalis S.p.A., San Donato Milanese, Milano (IT)

(21) Appl. No.: 18/725,824

(22) PCT Filed: Dec. 27, 2022
(86) PCT No.: PCT/IB2022/062799

§ 371 Date: Jul. 1, 2024

(30) Foreign Application Priority Data
Dec. 30, 2021 (IT) 102021000033044

(51) Int. Cl. C10B 53/07; B01J 6/00; C08J 11/12; C10B 57/14

(52) U.S. Cl. CPC C10B 53/07; B01J 6/008; C08J 11/12; C10B 57/14; C08J 2323/06; C08J 2423/06; C08J 2423/12

(57) ABSTRACT

This invention relates to the processing of plastics materials for re-use and valorisation in chemical recycling processes for the re-use of substantially plastics materials otherwise destined for disposal.

In particular the invention relates to a process for the pyrolysis of substantially plastics material to obtain at least liquid hydrocarbons that are in the liquid state at 25° C. comprising the following steps:
a) feeding the substantially plastics material optionally already in the molten and/or preheated state to a pyrolysis reactor;
b) bringing said material in said pyrolysis reactor to a temperature of between 330° C. and 580° C. in the substantial absence of oxygen and at a pressure of between atmospheric pressure and 13 bar (a);
c) holding said material in said pyrolysis reactor at a temperature of between 330° C. and 580° C. for a time sufficient to produce at least one effluent in the gaseous state in said pyrolysis reactor;
d) adjusting the pressure in said pyrolysis reactor in relation to characteristic parameters defined by the composition of said substantially plastics material and/or characteristic parameters defined by the products of said pyrolysis process, while maintaining said pressure at a value of between atmospheric pressure and 13 bar (a);
e) partly or totally condensing said effluent in the gaseous state so as to form at least one fluid comprising liquid hydrocarbons that are in the liquid state at 25° C. which quantitatively is at least 10% by mass with respect to the mass of substantially plastics material fed;
f) the process being characterized by the fact that the pressure adjustment of step d) has low latency.

This invention relates to the processing of plastics materials for use in chemical recycling processes for the re-use and valorisation of substantially plastics materials otherwise destined for disposal.

In particular the present invention relates to a process for processing substantially plastics materials of variable composition, the relative reactor and the product obtained.

Advantageously the present invention may be used to process substantially plastics materials pre-processed in a sorting plant, in which some types of plastics materials are identified and separated as individual polymers.

In this way the fractions which can be recovered as a single type of polymer can be reused as such, and only the part that cannot be recovered as an individual polymer will undergo pyrolysis. Following pyrolysis, there are produced hydrocarbons which, when subjected to further treatments such as steam cracking, generate monomers which can then be polymerised again to form virgin plastic.

It is clear that the cycle to regenerate plastics through pyrolysis is more expensive and complex than simple recovery or the selective extraction of individual polymers in a sorting plant, but it can lead to a total recovery of the waste plastics, with also substantial advantages from the environmental point of view.

### STATE OF THE ART

There are many articles and patent applications on processes for the pyrolysis of plastics, but only very few deal with the effect of pressure.

In reality, the processes in the known art relate to both processes under pressure and processes at reduced pressure and do not indicate one particular choice of operating conditions.

For example, ES2389799 discloses a process for the production of diesel oil (C13-C40) which involves two stages under pressure (1-15 bar (a)). The first stage is thermal, while the second is catalytic and in the presence of hydrogen. The feed material is preferably of polyolefin origin, that is it relates to polymers that can be simply recycled by sorting and which go beyond the scope of the present invention. It may contain polystyrene, but preferably the content of other plastics such as PVC and PET is less than 10%.

On the other hand a substantial part of the prior art, such as WO2013187788, WO0231082 and EP2184334, suggests pyrolysis carried out at reduced (sub-atmospheric) pressure.

For example, WO2013187788 (DAGAS SP ZOO, Poland) discloses a method for carrying out the pyrolysis of plastics and/or rubber and/or organic waste which includes subjecting said waste to a pyrolytic reactor in the absence of air at 200-850° C. and separating the products obtained, characterised in that the process is operated continuously and at a reduced pressure of between 0.1 and 0.9 atm. The plastics fed in the examples are mixtures of polythene and polypropylene, except for example 1 where 20% of polyamide is also fed. In addition to the charge to be pyrolysed, the reactor also contains a composition comprising water, an aliphatic alcohol, a carbamide (or its derivative) and monoacetylferrocene. Liquid hydrocarbons are produced, but not in large quantities (40% of the feed for example 1).

This prior art therefore demonstrates the advantages in operating the pyrolysis of plastics materials (mostly polyolefins) at sub-atmospheric pressures. The reaction conditions, in terms of both parameters (temperature, residence time) and type of reactor and possible catalyst, and in terms of product obtained, vary greatly.

From the examination of the known art it is clear that there are many pyrolytic processes carried out at pressures below or above atmospheric pressure, but there is no general teaching that makes it possible to establish whether it is advantageous to manage a pyrolytic process of complex polymeric mixtures at atmospheric pressure, at sub-atmospheric (reduced) pressure or in over-pressure (i.e. at a pressure higher than atmospheric pressure). The information available is often very varied, sometimes contradictory and provides completely different indications. Furthermore, none of the documents identified provide information on how to set the operating pressure of the pyrolytic system according to the quality of the polymer fed or the products obtained. In addition to this, the feed material is often relatively pure, mostly polyethylene or polyethylene-polypropylene mixtures. Furthermore, in no case the fed material does have a composition that is not constant, and in any case it is not known how to manage a change in composition and the effect on the process and on the product obtained.

The substantially plastics material remaining after the process of selection and extraction of individual polymers is instead by its nature of very variable composition (and therefore not constant) and composed of multiple types of plastics materials, as well as non-plastics materials.

Furthermore, the pyrolysis processes require that the plastics fed to them have been previously selected to reduce the quantity of difficult-to-treat plastics (such as PVC, PET, cellulose, polystyrene) and non-plastics materials, favouring polyolefins (especially polyethylene and polypropylene) instead. However, most of the polyolefins present in the substantially plastics material are generally separated out in said selection processes, and then recycled as such, without having to carry out pyrolysis. There is therefore particular interest in treating the residual fraction after selection with pyrolysis, that is, the one that is least used by the pyrolysis processes of the known art and which contains significant quantities of other plastics and smaller proportions of non-plastics materials in addition to a certain amount of polyolefins.

For the reasons indicated above, there is therefore a need to identify a process that can overcome the limitations of the known art.

### SUMMARY OF THE INVENTION

The Applicant has surprisingly found that a plastics material of inconstant composition can successfully undergo a pyrolysis process by adjusting the reaction conditions, and in particular the pressure, according to the composition of the material to be processed. The Applicant has therefore developed a process, preferably a continuous or semi-continuous process, for the pyrolysis of substantially plastics material to obtain at least liquid hydrocarbons that are in the liquid state at 25° C. by subjecting a substantially plastics material to a specific pyrolytic process, also of inconstant composition, optionally also comprising large quantities of components normally considered undesirable.

This process comprises the step of feeding said material to a pyrolysis reactor at a temperature of between 330° C. and 580° C. in the substantial absence of oxygen, and at a pressure of between atmospheric pressure and 13 bar (a), and is characterised in that it comprises the step of regulating the pressure in the pyrolysis step according to the composition of said substantially plastics material and/or the products of said pyrolysis process, where such pressure regulation is preferably characterized by a reduced latency. Furthermore, the pyrolysis process is preferably characterised in that said substantially plastics material has an inconstant composition.

One advantage of the process disclosed in the present invention is that, when integrated with a pre-selection process, it allows plastics to be recycled an indefinite number of times (“closed loop recycling”), i.e. such that the material can be used and then regenerated several times without losing its properties during the recycling process.

A further advantage of the process disclosed in the present invention is the ability of the process to treat substantially plastics material comprising vinyl polymers (polyethylene and polypropylene), polyvinyl aromatic polymers, such as polystyrene (PS) and its associates, non-vinyl polymers (such as for example s polyethylene terephthalate (PET) and polymers rich in oxygen (such as for example cellulose and PET itself), without any process problems such as fouling or blocking, and with a high quality of said liquid hydrocarbons that are in the liquid state at 25° C.

A further advantage of the process disclosed in the present invention is the ability of the process to treat substantially plastics material also comprising high quantities of components normally considered undesirable such as paper and cardboard (cellulose) and chlorinated or brominated compounds, such as polyvinyl chloride (PVC) and polymers containing halogenated flame retardants.

A further advantage of the process disclosed in the present invention is the ability of the process to treat substantially plastics material of inconstant composition, without the occurrence of fouling and blocking.

A further advantage of the process disclosed in the present invention is the ability of the process to treat substantially plastics material which is the residue that it has not been possible to separate and recycle in the selection processes that are generally applied to plastics waste.

A further advantage of the process disclosed in the present invention is the ability of the process to produce a high quality pyrolysis oil in terms of the composition obtained, even when the substantially plastics material treated is of inconstant composition, maintaining a substantial high quality of the liquid hydrocarbons produced at 25° C.

The present invention also relates to a mixture which includes hydrocarbons in quantities greater than 90% by weight and tetrahydrofuran in quantities between 0.01% and 0.25% by weight, with respect to the total weight of the mixture, and use of said mixture to feed a cracking plant.

The present invention also relates to a reactor for the pyrolysis of substantially plastics material to obtain at least liquid hydrocarbons that are in the liquid state at 25° C., and an apparatus for the pyrolysis of substantially plastics material to obtain at least liquid hydrocarbons that are in the liquid state at 25° C. comprising at least one reactor for the pyrolysis of substantially plastics material and at least one pressure regulating system for said reactor that depends on a characteristic evaluated on the substantially plastics material fed and/or a characteristic evaluated on the pyrolysis oil produced by said reactor, where such pressure regulating system is characterized by a reduced latency.

### Definitions

In the description of the present invention, unless otherwise specified, the values of ranges (for example ranges of pressure, temperature, quantity, etc.) are to be considered to include the extremes.

In the description of the present invention, unless otherwise specified, percentages are to be understood to be percentages by weight (i.e. by mass). The symbol “%” means percent, always by weight (mass).

In the description of the present invention the term “comprises” also includes as a particular limiting case its meaning as “consists of”.

In the description of the present invention the term “essentially consists of” means that the composition or formulation (a) necessarily includes the listed ingredients and (b) is open to unlisted ingredients that do not materially affect the basic properties and innovative properties of the composition.

In the description of the present invention, by latency it is meant the time delay from the beginning of the measurement of the characteristic parameter evaluated on the substantially plastics material fed and/or the characteristic parameter evaluated on the pyrolysis oil produced by said reactor to the moment when the pressure set-point is set. In other words, it is the difference between the time when the pressure set-point is set, and the time when said measurement is started.

In the description of the present invention, unless otherwise specified, to maintain a certain parameter (for example the pressure) within an indicated range means operations are actively performed so that this parameter falls within the range, for example by checking that the measured value falls within the indicated range, and/or regulating the parameter by means of a feedback regulating system in which a value of this parameter is set within the indicated range. Preferably, holding a certain parameter (for example the pressure) at the set value or within an indicated range indicates that in a feedback control system this parameter is set at a value within the indicated range so as to bring the parameter to the set value or within the indicated range.

In the description of the present invention, unless otherwise specified, liquid hydrocarbons that are in the liquid state at 25° C. mean hydrocarbon mixtures which are in the liquid state at 25° C. at atmospheric pressure.

In the description of the present invention, by pyrolysis oil is meant the product of pyrolysis which is in the liquid state at 25° C. at atmospheric pressure (generally obtained by condensation of the pyrolysis vapours). Thus the pyrolysis process according to the present invention produces a pyrolysis oil which comprises hydrocarbons.

In the description of the present invention, by pyrolysis vapours are meant the product which is generated during the pyrolysis process which is in the gaseous state in the pyrolysis reactor, or which is in the gaseous state under the conditions of temperature, pressure and composition in the pyrolysis.

In the description of the present invention, by pyrolysis residue is meant the product which is in the liquid, solid, or liquid and solid state in the pyrolysis reactor, or which is in the liquid and/or solid state under the conditions of temperature, pressure and composition in the pyrolysis.

In the description of the present invention, unless otherwise specified, by substantial absence of oxygen is meant that the oxygen (understood as molecular oxygen) in the pyrolysis vapours is less than 2% by weight, preferably less than 0.8% by weight, even more preferably between 20 and 4000 ppm by weight, with respect to the total weight of the composition of said vapours.

In the description of the present invention, by reactor/apparatus specifically designed for pyrolysis of substantially plastics material is meant that said reactor/apparatus has as its purpose the treatment of substantially plastics material to produce at least liquid hydrocarbons that are in the liquid state at 25° C.

In the description of the present invention, unless otherwise specified, by nozzle is meant an opening made in the body of a device, for example the pyrolysis reactor, to allow the entry or exit of a material, or to fit a sensor to measure a physical property (for example: temperature, pressure, level), or to allow the insertion of further elements (for example: agitator, heating coils, baffles), without referring to any particular fixing method (for example: flanged or threaded) or to the shape of the same, although the circular shape is preferred.

In the description of the present invention, unless otherwise specified, for a value of a parameter that is equal to at most a determined value X, it is meant that the parameter is equal to X or less than X; and for a value of a parameter that is equal to at least a certain value X, it is meant that the parameter is equal to X or greater than X.

In the description of the present invention, unless otherwise specified, by yield in the production of a product is meant the percentage by weight of that product with respect to the total of products made.

Unless otherwise specified, in this document “part” and “parts” mean respectively parts by weight and parts by weight. Weight means mass, i.e. kg in SI units. Unless otherwise specified, the unit of measure of pressure is the bar. In case not expressly defined and in case the pressure can refer both to absolute or relative (gauge) value, the absolute value is intended.

### DESCRIPTION OF THE FIGURES

FIG. 1 shows a reactor for the pyrolysis of substantially plastics material for obtaining at least liquid hydrocarbons that are in the liquid state at 25° C. according to the invention;

FIG. 2 shows one embodiment of a demister of inertial type (cyclone) according to the invention;

FIG. 3 shows embodiments of a reactor bottom (lower or upper);

FIG. 4 shows diagrammatically an apparatus for the pyrolysis of substantially plastics material for obtaining at least liquid hydrocarbons that are in the liquid state at 25° C. according to the invention;

FIG. 5 shows some embodiments of pressure control according to the present invention;

FIG. 6 shows an embodiment of the split-range control mode according to the present invention;

FIG. 7 shows a graph comparing two different T1 and T2 temperature profiles applied to the pyrolysis reaction.

### DETAILED DESCRIPTION OF THE INVENTION

A first aspect of the present invention is a process for the pyrolysis of substantially plastics material to obtain at least liquid hydrocarbons that are in the liquid state at 25° C. comprising the following steps:
a) feeding the substantially plastics material optionally already in the molten and/or preheated state to a pyrolysis reactor;
b) Bringing said material in said pyrolysis reactor to a temperature of between 330° C. and 580° C. in the substantial absence of oxygen and at a pressure of between atmospheric pressure and 13 bar (a);
c) holding said material in said pyrolysis reactor at a temperature of between 330° C. and 580° C. for a time sufficient to produce at least one effluent in the gaseous state in said pyrolysis reactor;
d) adjusting the pressure in said pyrolysis reactor in relation to characteristic parameters defined by the composition of said substantially plastics material and/or characteristic parameters defined by the products of said pyrolysis process, while maintaining said pressure at a value of between atmospheric pressure and 13 bar (a);
e) partly or totally condensing said effluent in the gaseous state so as to form at least one fluid comprising liquid hydrocarbons that the liquid state at 25° C. which quantitatively is at least 10% by mass with respect to the mass of substantially plastics material fed;
the process being preferably characterized by the fact that the pressure adjustment of step d) has low latency.

Low latency means that latency is not more than 600 seconds, preferably not more than 100 seconds. According to one embodiment it is not more than 50 seconds, even more preferably between 0.1 and 15 seconds.

In step d), any characteristic parameter defined by the composition of the substantially plastics material and/or characteristic parameters defined by the products of said pyrolysis process can be used to adjust the pressure, as long as the measurement of such characteristic parameter(s) is compatible with the specified latency time requirements.

That means in particular that any measurement that takes more time than the specified latency time requirement is not part of the present invention.

The following measurement methods, that can be used both on the substantially plastics material and the products of the pyrolysis process, are characterized by a latency time that can be within the specified latency time requirements:
UV-Vis absorption spectroscopy
Fluorescence emission spectroscopy
X-ray fluorescence emission spectroscopy (XRF)
X-ray dispersion spectroscopy (EDX)
Fourier transform mid-infrared absorption spectroscopy (FTIR)
Fourier transform near infrared absorption spectroscopy (FT-NIR)
Raman absorption spectroscopy
Rotovibrational microwave spectroscopy
Dynamic light scattering (DLS)
Circular dichroism
Photoacoustic spectroscopy
Ultrafast laser spectroscopy
Laser-induced Breakdown Spectroscopy (LIBS)

The time delay between the measurement of such characteristics and the definition of the set-point of the pressure can be very low (typically, less than 1 second, even more preferably less than 0.1 seconds), when the computation of said set-point is carried out automatically by means of a digital computation means, such as a computer, a distributed control system (DCS), a microcontroller, a programmable logic controller (PLC) or a field-programmable gate array (FPGA), and combinations thereof.

Therefore, according to one embodiment, the adjusting the pressure in said pyrolysis reactor in relation to characteristic parameters defined by the composition of said substantially plastics material and/or characteristic parameters defined by the products of said pyrolysis process, while maintaining said pressure at a value of between atmospheric pressure and 13 bar (a) is characterized by the fact that said characteristic parameter(s) is measured with at least one of the aforementioned measurement methods. According to a further embodiment, preferably said adjustment of the pressure is carried out by computing the pressure set-point with one of the above mentioned digital computation means.

As an effect of the reduced latency, it has been found that surprisingly a robust, stable and reliable pressure control is obtained, in particular when the substantially plastics material feed is inconstant, and more in particular when the substantially plastics material is characterized by high variability, as disclosed later in more detail.

The pressure regulation mentioned in step d) is preferably carried out at least during pyrolysis of the substantially plastics material contained in the reactor, so that said regulation is preferably carried out at least during step c), i.e. while the substantially plastics material is kept at a temperature between 330° C. and 580° C. for a time sufficient to produce at least one effluent in the gaseous state in said pyrolysis reactor.

The fluid comprising hydrocarbons condensed in step e) which is in the liquid state at 25° C. is the pyrolysis oil.

Preferably, said substantially plastics material consists of compositions of different plastics. Even more preferably, said compositions of different plastics comprise at least polymers with a high H/C index such as for example polyethylene, polypropylene, polyamides, polymethyl methacrylate and polymers with a low H/C index such as polystyrene, polycarbonate, polyethylene terephthalate.

Alternatively, or in combination, said compositions of different plastics include high carbon index polymers such as polyethylene (including LDPE, LLDPE, HDPE), polypropylene, polystyrene, elastomers and low carbon index polymers such as polyamides, polymethyl methacrylate, polyethylene terephthalate, polyvinyl chloride and cellulose.

Preferably said substantially plastics material is characterised by an H/C index of at least 70, preferably between 80 and 98, even more preferably between 85 and 96.

Preferably, said substantially plastics material is characterised by a carbon index of at least 55, preferably between 65 and 95, even more preferably between 75 and 90.

The H/C index is proportional to the ratio of the total mass of hydrogen atoms to the total mass of carbon atoms present in the substantially plastics material, and is calculated using the following formula:

$$H / C Index = 100 \cdot \frac{12}{2} \cdot \frac{Weight H atoms}{Weight C atoms}$$

The carbon index is proportional to the ratio of the total mass of carbon atoms to the total mass of all atoms present in the substantially plastics material, and is calculated using the following formula:

$$Carbon Index = 100 \cdot \frac{Weight C atoms}{Weight ALL atoms}$$

where “weight of ALL atoms” corresponds to the weight of the substantially plastics material.

In particular embodiments, said substantially plastics material contains at least one non-plastics material in an amount ranging from 0.01% to 10% by weight with respect to the weight of the substantially plastics material, or an amount ranging from 0.05% to 7.5%, or an amount ranging from between 0.2% and 5%, or amounts between 1.1% and 4%. Said non-plastics material preferably includes at least one of the following materials: paper, cardboard, wood, compost (as defined by IUPAC in “Terminology for biorelated polymers and applications (IUPAC Recommendations 2012)”, Pure Appl. Chem., Vol. 84, No. 2, pp. 377-410, 2012, DOI 10.1351/PAC-REC-10-12-04), metal materials such as aluminium and iron, and/or inert materials.

In particular embodiments said substantially plastics material contains inorganic fillers such as silica, titanium oxide, talc, coke, graphite, carbon black, calcium carbonate, tricalcium phosphate, zeolites, aluminium silicates, geopolymers, titanates, perovskites. In particular embodiments said fillers may be present in amounts of 0.01-10%, preferably 0.1-5%, with respect to the total weight of the substantially plastics material. In particular embodiments the substantially plastics material has a final inorganic residue (ash), measured according to the method described herein, of at least 0.01%, preferably between 0.1% and 20%, more preferably between 0.4 and 12%, even more preferably between 1.1% and 7%, with respect to the weight of the substantially plastics material. In particular embodiments said substantially plastics material contains brominated and chlorinated additives, in particular organo-brominated and organo-chlorinated additives used to make the plastics material fireproof, or in any case impart flame retardant properties. Examples of said additives are hexabromocyclododecane, decabromo-diphenyl oxide, polybrominated diphenyl ethers, and brominated polymers such as brominated styrene-butadiene copolymers or brominated polystyrene. In particular embodiments the halogen content present in the substantially plastics material is in an amount of 0.01-10%, preferably 0.1-3%, with respect to the total weight of the substantially plastics material.

In particular embodiments said substantially plastics material contains non-halogenated additives used to make the plastics material fireproof or in any case to impart flame retardant properties, such as phosphorus and nitrogen compounds.

If the substantially plastics material contains one or more of said materials or substances the pyrolysis process according to the invention is not adversely affected.

By “inconstant composition” of the substantially plastics material is meant that the composition fed to the pyrolysis reactor mentioned in step a) is variable. In particular embodiments, the composition is variable in that the amount of at least one component of said substantially plastics material varies by at least 1%, preferably at least 2%, more preferably at least 5%, even more preferably at least 10% by weight with respect to the weight of the substantially plastics material. In particular embodiments the composition is variable in that the atomic composition, understood as the weight of an element in the periodic table, i.e. the mass of all the atoms of that element in the substantially plastics material, such as carbon or hydrogen, varies by at least 1%, preferably at least 2%, more preferably at least 5%, even more preferably at least 10% by weight with respect to the weight of the substantially plastics material. In particular embodiments the composition is variable in that the hydrogen to carbon index (H/C index) and/or the carbon index varies by at least 1%, preferably at least 2%, more preferably at least 5%, even more preferably at least 10%.

In one embodiment the variability is between different production batches. Alternatively or in combination, the composition is not constant because there is variability of composition even within the same batch, for example due to stratification of the material. In fact there can be stratification during transport, and this generally gives rise to an increase in the concentration at the bottom of the heavier and/or small-sized or powdery plastics, and at the top of the lighter and/or large-sized plastics.

Alternatively, said substantially plastics material is not of constant composition because it is supplied by different manufacturers or suppliers. Each manufacturer may have different production specifications, and/or different production processes, so the product obtained is different.

In one embodiment, the variability of the substantially plastics material fed into the pyrolysis reactor mentioned in step a) is within a time period of one week, preferably within a time period of 3 days, even more preferably within the time period of a day, even more preferably within the time period of 12 hours, even more preferably within the time period of 3 hours, even more preferably within the time period of 1 hour, even more preferably within the time period of 30 minutes, even more preferably within the time period of 15 minutes.

Preferably said substantially plastics materials are also recycled.

In particular embodiments said substantially plastics materials also contain halogenated components in quantities ranging from 0.01% to 10% by weight with respect to the weight of the substantially plastics material.

Preferably, said substantially plastics materials are obtained by a process of sorting plastics material. Even more preferably, said substantially plastics materials are the residual substantially plastics material, that is the substantially plastics fraction which remains after having recovered some plastics, or after having selectively extracted some plastics from the substantially plastics material fed to the selection process. Selective extraction consists of the extraction of substantially uniform material of certain plastics (i.e. as monoplastic). Typically, in a selection process (sorting) it is possible to extract substantially pure plastic streams (i.e. as monoplastic) of the components polyethylene, polypropylene and polyethylene terephthalate. In this preferred selection, the residual substantially plastics material is therefore the material which results after extraction of said substantially pure plastics. This fraction is known in Italy by the term “Plas Mix” or “Plasmix”, which is defined as the “set of heterogeneous plastics included in post-consumer packaging and not recovered as single polymers” (art. no. 1 of draft Atto Camera law 4502 of May 18, 2017).

This substantially plastics material can be further selected to eliminate non-recyclable materials, or used as such.

In particular, according to a preferred method, said substantially plastics materials, possibly obtained by a process of sorting plastics material as defined above, are pretreated before being used in the pyrolysis process according to the present invention.

This pre-treatment preferably comprises an appropriate wash to remove at least some of the organic matter. Preferably, said pre-treatment also comprises, alternatively or in combination, the elimination of non-organic solid particulate, such as for example ferrous material and crushed stone.

A second aspect of the present invention is a reactor for the pyrolysis of substantially plastics material for obtaining at least liquid hydrocarbons that are in the liquid state at 25° C. comprising:
i) At least one port for exit of the gaseous product located on the top of the reactor or at a distance from the top of the reactor not greater than ⅓ of the height of the reactor;
ii) At least one port for extraction of the solid product located at the bottom of the reactor or at a distance from the bottom of the reactor not greater than ⅓ of the height of the reactor;
iii) At least one port for entry of the substantially plastics material at a distance from the top of the reactor greater than the distance of said port for the outlet of the gaseous product from the top of the reactor;
iv) At least one stirrer;
v) At least one jacket for heating the reactor
vi) At least one opening for inserting a temperature transducer
vii) At least one opening for inserting a pressure transducer
viii) At least one opening for inserting a sensor for measuring the level in the reactor,
characterised by the presence of a separator for carried over material (demister) placed under and/or at said port for exit of the gaseous product. According to one embodiment, said reactor is also characterised by a design pressure of at least 3 bar absolute, preferably at least 4 bar absolute, even more preferably at least 6 bar absolute, and by a design temperature of at least 330° C., preferably at least 380° C., still more preferably at least 430° C., still more preferably at least 480° C. According to one embodiment said reactor is also characterised by a substantially convex profile (i.e. a concave volume of more than 10% of the total volume of the reactor).

According to one embodiment, in said stirrer iv) at least one agitator element which agitates the fluid in the non-gaseous state is placed at a height equal to or lower than said port for the entry of substantially plastics material.

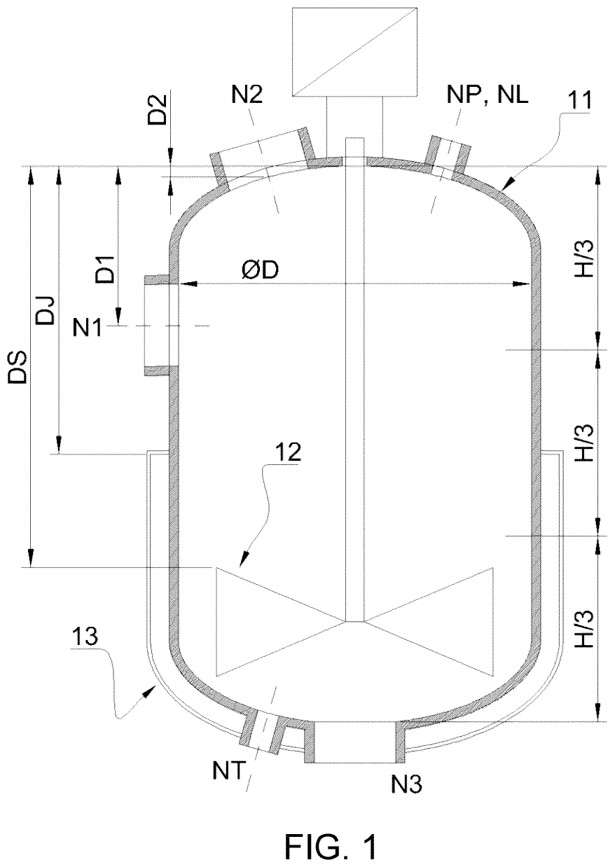

FIG. 1 shows one example of a reactor comprising:
a body (11) in which the pyrolysis reaction of said substantially plastics material takes place;
a stirrer (12) for moving and mixing said substantially plastics material and the pyrolysis products;
a jacket (13) in which flows the heat-transfer fluid which supplies the heat necessary to heat said substantially plastics material for pyrolysis;
a port (N1) for the entry of substantially plastics material;
a port (N2) for the exit of the gaseous product (i.e. the pyrolysis vapours);
a port (N3) for extraction of the product which is in the solid, liquid state and/or related mixtures (i.e. the pyrolysis residue);
an opening (NP) for inserting a sensor for measuring pressure;
an opening (NL) for inserting a sensor for measuring the level;
an opening (NT) for inserting a sensor for measuring the temperature;

Also shown in the figure are:
the height (D1) corresponding to the distance from the top of the reactor to the centre of port (N1);
the height (D2) corresponding to the distance from the top of the reactor to the centre of port (N2);
the height (DJ) corresponding to the distance from the top of the reactor to the highest point of the reactor body (11) heated by the jacket (13);
the height (DS) corresponding to the distance from the top of the reactor to the highest point of the mixing elements of the stirrer;
the height corresponding to the distance from the bottom of the reactor to the centre of port (N3) is instead not shown as it is equal to zero in the drawing in the Figure;
the height of the reactor (H) corresponding to the distance from the top to the bottom of the reactor, i.e. the maximum axial distance with respect to the vertical;
the height (H/3) corresponding to one third of the height of the reactor (H).

All the distances mentioned above are intended to be vertical distances, i.e. measured axially with respect to the vertical and therefore not the point-to-point distance (which is equal to or longer, the horizontal distance also contributing to the latter according to the Pythagorean theorem).

All the distances mentioned above are measured on the inside of the reactor body (11), i.e. for example the height of the reactor (H) is measured on the inside, as shown in FIG. 1.

As mentioned, the reactor has a substantially convex profile. Convex profile means that for any two given points inside the reactor the segment that joins them is entirely within the reactor. By segment inside the reactor is meant that each point of the segment is within the reactor or placed on the internal surface thereof. By substantially convex profile is meant that the concave volume is at most 10% of the total reactor volume, preferably at most 5% of the total reactor volume. Concave volume means the volume within which there is at least one point for which it is possible to identify another point within the reactor (but not necessarily within said concave volume) for which the segment joining them is not entirely within the reactor. As a special case the substantially convex profile is a convex profile.

Preferably the reactor body is substantially axially symmetrical, i.e. it has an axis of symmetry and its shape is substantially obtainable by the revolution of a profile through 360 degrees. Axially symmetrical shapes are for example the flat end (obtained by revolution of a rectangular profile having the axis of symmetry perpendicular to the longest side of the rectangle), the tubular profile (obtained by revolution of a rectangular profile having the axis of symmetry parallel to the longest side of the rectangle), the tapering end (obtained by revolution of a rectangular profile not aligned with respect to said axis of symmetry), and the spherical (also called hemispherical), elliptical or semi-elliptical end (obtained by revolution of a curved profile).

Preferably the reactor body is formed by a shell composed of three parts rigidly connected at the ends, one of which is said central body, preferably having a cylindrical or tapering profile, and/or a composition of the cylindrical and tapering profile, the internal surface of which forms the internal lateral surface of the reactor, plus an upper end and a lower end.

Said ends are preferably rigidly connected to said central part at their extremities so as to form a substantially closed body which can therefore be pressurised.

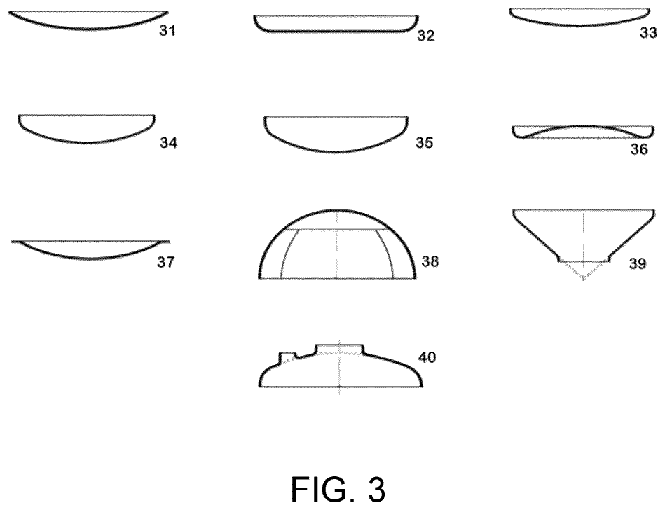

Even more preferably the ends are according to one of the geometries indicated in FIG. 3.

More preferably, the lower end is of the pseudo-elliptical, elliptical or hemispherical type. Even more preferably the lower end is of the hemispherical type.

More preferably, the upper end is of the flat, pseudo-elliptical, elliptical, or hemispherical type. Even more preferably the upper end is of the hemispherical type.

Said rigid connection between the end and the central body may be made by any method known in the art, for example by welding, brazing, riveting or by means of a flanged coupling.

By substantially axially symmetrical reactor body is meant that at most 15% of the reactor volume cannot be obtained by the revolution of a profile through 360 degrees and must therefore be added or subtracted from said volume produced by the revolution of said profile through 360 degrees.

The reactor is preferably of the vertical type, i.e. with the axis of symmetry of the shell parallel to the vector of the weight force (gravitational force).

The Applicant has noted that the reactor geometry as disclosed in the present invention, and in particular with a substantially convex profile, makes it possible not only in general to reduce the thickness required to withstand the relatively high process pressures required by the present process, but also to limit fouling. The reduction in thickness also makes it possible to increase heat exchange with the fluid in the jacket and make it more uniform, as the thermal resistance through the thickness of the reactor body is reduced.

A third aspect of the present invention is an apparatus for the pyrolysis of substantially plastics material to obtain at least liquid hydrocarbons that are in the liquid state at 25° C. comprising:
at least one reactor for the pyrolysis of substantially plastics material;
at least a condensation separator of the vapours produced by said reactor
at least one system for regulating pressure in said reactor in relation to a characteristic evaluated on the substantially plastics material fed and/or a characteristic evaluated on the pyrolysis oil produced by said reactor and/or the liquid hydrocarbons that are in the liquid state at 25° C. produced.

According to one embodiment, in the apparatus for the pyrolysis of substantially plastics material the system regulating pressure in said reactor operates according to one or more of the following modes:
regulation of the heat extracted from the condensation separator located downstream of the reactor and in fluid connection therewith, preferably by regulating the power of the condensation separator;
when an auxiliary gaseous fluid is supplied, adjustment of the flow rate of said auxiliary gaseous fluid;
control of pressure regulation of the pyrolysis vapours by adjusting the opening of a valve through which the pyrolysis vapours pass before entering at least one condensation separator;
control of pressure regulation of the residual gas by adjusting the opening of a valve through which passes the residual gas consisting of the fluid comprising hydrocarbons which has not been condensed after passing through at least one condensation separator;
double control of pressure regulation by combination of the control mode for pressure regulation of the pyrolysis vapour and the control mode for pressure regulation of the residual gas.

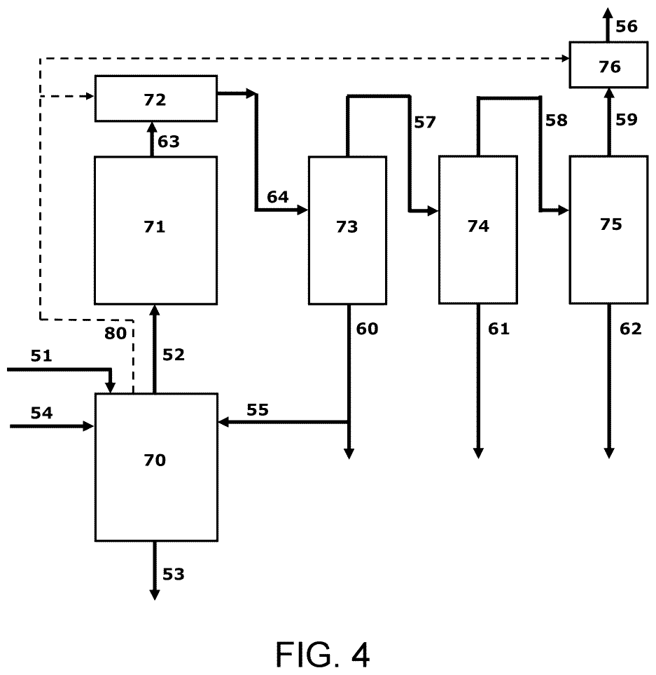

A diagrammatical view of one embodiment of said apparatus is illustrated in FIG. 4, and shows:
a reactor (70) for the pyrolysis of substantially plastics material (54) which produces pyrolysis vapours (52) and a solid residue (53), and which optionally receives an auxiliary gaseous fluid (51);
a second reactor (71) which subjects the pyrolysis vapours (52) coming from the pyrolysis reactor (70) to a thermal or thermal catalytic treatment;
a first pressure control device (72), for example a valve, which acts through feedback in relation to the value of the pressure (80) measured in the pyrolysis reactor (70), and which receives the pyrolysis vapours (63) from the second reactor (71) (but which, in an alternative embodiment, can instead be located between reactor (70) and reactor (71), i.e. receiving the pyrolysis vapours (52));
a first condenser (73) which receives the pyrolysis vapours (64) and the condensates (60) of which are partly returned (55) to the pyrolysis reactor (70);
a second condenser (74) which receives the vapours (57) coming from the first condenser (73) producing a second condensate (61) and vapours (58);
a third condenser (75) which receives vapours (58) from the second condenser (74) producing a third condensate (62) and uncondensed vapours or the residual gas (59);
a second device for controlling the pressure (76) acting through feedback in relation to the value of the pressure (80) measured in the pyrolysis reactor (70), for example a valve that restricts the cross-section of the passage for the residual gas leaving the condenser (59) before sending the residual gas (56) to the unit capable of receiving it.

If in said pressure regulating system said characteristic is evaluated on the substantially plastics material fed into the reactor, it is preferred that regulation should take place in relation to the H/C index (H/C index) and/or the carbon index (carbon index) of said substantially plastics material, or on the basis of a mathematical relationship which takes into account both said H/C index and said carbon index.

If in said pressure regulating system said characteristic is evaluated on the pyrolysis oil produced by said reactor and/or on the liquid hydrocarbons produced at 25° C., it is preferred that said characteristic be the refractive index, viscosity or molecular weight of said pyrolysis oil.

### Preferred Modes of the Process According to the Present Invention

According to a preferred method, the substantially plastics material fed to the reactor in step a) is previously melted and/or preheated in a preheating apparatus. Said preheating apparatus may be a single screw extruder, a twin-screw extruder or an auger. Said preheating apparatus may be equipped with degassing for the evacuation of water vapour and any other gases produced, such as in particular hydrogen chloride (HCl).

For this purpose, it may be advantageous to also feed said preheating apparatus with additives capable of favouring the evolution of hydrochloric acid or turn it into salts, in addition to said substantially plastics material. Such additives are preferably composed of the elements in groups IA and IIA. Even more preferably oxides, hydroxides, carbonates, silicates and they are aluminosilicates from groups IA and IIA. Even more preferably they are calcium oxide, calcium hydroxide, calcium carbonate, sodium oxide, sodium hydroxide, sodium carbonate, potassium oxide, potassium hydroxide, potassium carbonate, sodium aluminosilicate.

The preheating temperature may be between 120° C. and 430° C., preferably between 150° C. and 320° C., even more preferably between 180° C. and 220° C. The residence time in said preheating apparatus is preferably less than 10 minutes, even more preferably less than 2 minutes, in particular between 15 seconds and one minute.

Said process for pyrolysis of substantially plastics material to obtain at least liquid hydrocarbons that are in the liquid state at 25° C. may be carried out in batch mode, in continuous mode, and in semi-continuous mode. In the latter mode, the substantially plastics material is loaded continuously, the generated vapours are continuously extracted, but any solid residue is kept inside the pyrolysis reactor.

When the quantity of solid residue inside the reactor rises above a certain threshold, or at predefined time intervals, for example with a frequency ranging from 2 to 10 days, the material contained in the reactor and therefore said solid residue is removed.

Preferably the reactor is operated in continuous or semi-continuous mode, even more preferably in semi-continuous mode.

Although the reactor described above is preferred, the pyrolysis process according to the present invention is not limited by a particular type of reactor.

In particular, horizontal or vertical, stirred or non-stirred reactors, kiln reactors or screw reactors may be used. Fluidised bed reactors, on the other hand, are not preferred.

Among stirred reactors continuously stirred reactors (CSTR) and multizone reactors may be used. Piston flow reactors (PFRs), preferably stirred in order to facilitate thermal transport may also be used.

Among the continuously stirred reactors (CSTR), totally filled reactors and reactors in which a separation of the gaseous phase from the phase that includes the liquid and other possible phases such as the solid (char) product, i.e. reactors in which there is a free surface, may be used.

Preferably the reactor is a stirred reactor. Preferably the reactor has a free surface, that is a surface which substantially separates the gaseous phase from the substantially non-gaseous phase. The substantially non-gaseous phase is for example the phase comprising the solids, the liquids, by liquids also meaning the molten material such as for example the substantially plastics material fed. Said substantially non-gaseous phase may in any case comprise the gaseous phase, for example the bubbles of the vapours of the pyrolysis products that rise up into the reactor.

Step b) of the process according to the present invention is carried out in the substantial absence of oxygen. Normally, the substantially plastics material does not develop significant quantities of molecular oxygen during pyrolysis, so this condition is normally automatically reached after a few hours after the process has started. However, to avoid self-combustion phenomena, after the cycle stops and/or the reactor is opened it is preferable to inject an auxiliary gaseous fluid. An example of possible auxiliary gaseous fluid is an inert gas in the reaction conditions of the pyrolysis (meaning that it does not react substantially at the process conditions of the pyrolysis reactor). Example of such inert gases are nitrogen, argon, water vapor, carbon dioxide and relative mixtures. Such gases can be fed before feeding the substantially plastics material into the pyrolysis reactor, in order to remove the oxygen present in the air. Other possible choices for the auxiliary gaseous fluids are given below.

The temperature to which the material is brought in said pyrolysis reactor is from 330° C. to 580° C., preferably from 340 to 540° C., even more preferably from 360 to 500° C., even more preferably from 380 to 480° C., even more preferably from 410 to 450° C.

The temperature of the material in the pyrolysis reactor may be measured by any method known in the art. For example, it is possible to use thermocouples with a facing membrane aligned with the internal surface of the reactor, in order to reduce fouling; or well thermocouples for a more precise measurement inside the reactor; or thermocouples which measure the temperature of the metal near the surface of the reactor wetted by the polymer; or non-contact, for example infra-red, measuring systems. Multiple systems may be used simultaneously for better reliability.

The temperature may be adjusted by acting on the thermal power introduced into the reactor. Said thermal power may be introduced through the use of any technique known in the art, such as for example a reactor equipped with a heating jacket in which a suitable heat transfer fluid flows, or with a direct electric heating system by the Joule effect, or even electric induction heating. Heating may also be effected using microwaves. Heating by a heating jacket is particularly preferred.

If a heat transfer fluid is used, this may be a molten salt. Preferably, this heat transfer fluid has a low melting point. More preferably, said melting point is at most 310° C., even more preferably at most 250° C., even more preferably at most 220° C. Preferably, this heat transfer fluid has a high decomposition temperature. More preferably, said decomposition temperature is at least 400° C., more preferably at least 450° C., even more preferably at least 490° C., even more preferably at least 540° C.

Preferably, this heat transfer fluid has a low chloride content. Preferably, the chlorides are lower than 1000 ppm by weight. Even more preferably, the chlorides are less than 100 ppm by weight.

According to one embodiment, the heat transfer fluid is a molten salt comprising nitrates and metal carbonates from groups IA and IIA, preferably sodium nitrate, sodium nitrite, potassium nitrite, potassium nitrate, lithium nitrate, calcium nitrate and their mixtures. According to a further embodiment, the heat transfer fluid is a molten salt comprising carbonates of metals from groups IA and IIA, preferably a carbonate of lithium, calcium, sodium, potassium and mixtures thereof. According to a further embodiment, the heat transfer fluid is a molten salt comprising fluorides of metals from groups IA and IIA, preferably lithium, sodium, potassium and calcium fluoride. Even more preferably, the heat transfer fluid consists of a molten salt comprising sodium nitrite, sodium nitrate and potassium nitrate. Even more preferably, the heat transfer fluid consists of a molten salt comprising sodium nitrate and potassium nitrate. If a pre-heating device is used, the heat transfer fluid can advantageously be fed first to the pyrolysis reactor and then to the pre-heating, or fed in parallel.

According to one embodiment, the heat transfer fluid is a heat transfer fluid of organic bases, of semi-synthetic or synthetic origin (such as for example Dowtherm A, Marlotherm SH, Mobiltherm, Santotherm, Therminol 66, Therminol SP). According to a further embodiment, the heat transfer fluid is a silicone fluid (such as Syltherm 800, Duratherm S or Gelest PDM 0821). These silicone fluids allow operation at higher temperatures (even over 380° C.), without the need for pressurisation. The use of silicone fluids also makes it possible to significantly reduce the replacement of the fluid, as the thermal stability is higher. According to a preferred method, the pyrolysis vapours produced by the pyrolysis reactor are subsequently passed through at least one condensation separator so as to recover at least liquid hydrocarbons that are in the liquid state at 25° C. (as defined in the present invention).

By condensation separator is meant any apparatus which receives a fluid in the gaseous state and is capable of removing sufficient heat from said fluid so as to generate at least a part of fluid in the liquid state.

Examples of equipment are condensers, for instance condensers comprising coils inside which a heat transfer fluid flows, that are capable of removing the heat from the fluid in the gaseous state being processed.

Other methods of removing heat may also be used, for example alternatively or in combination the condensation separator may be equipped with a jacket in which said heat transfer fluid capable of removing heat flows.

Advantageously, a flooding condenser may also be used, in which the condenser is partly flooded by the liquid phase produced, and the condensing power of which is regulated by varying the depth of said liquid phase, since only the coil that is not flooded is able to absorb calories from the steam to be condensed. This therefore allows effective regulation of the condenser power.

Alternatively, the condensation separator may consist of a distillation column. In this case the condensed fluid originates in the column condenser and the condensed liquid flows back into the column by gravity or by pumping, condensing the vapours that are inside the column. By using a condensation separator of the distillation column type, better fractionation of the incoming vapours, i.e. the separation between higher boiling components that are condensed and lower boiling components that remain in the vapour phase, is also obtained, as each equilibrium stage allows the liquid phase to be enriched in heavy components and the gas phase to be enriched in light components. In addition, the condensed liquid that falls back into the column scrubs the vapours inside the distillation column. This has the result of picking up any solid particulate present in the incoming vapours, which ends up being collected in the liquid phase.

A further advantage of using the distillation column is that, in comparison with a single condenser (which is substantially equivalent to an equilibrium stage separator), the column can be operated at a higher temperature, to obtain the same effluents in the gaseous state. This is an advantage because the temperature of the pyrolysis reactor is normally higher than the condensation temperature in said condensation separators. Therefore, when the liquid effluent of said distillation column is partly recycled to the pyrolysis reactor, the higher temperature of said recycled condensate makes it possible to reduce the thermal energy that must be supplied to said pyrolysis reactor.

Advantageously, the column does not have a boiler and the inlet for the vapours into the column is positioned in the lower half of the column, even more preferably at the bottom.

The power of the condensation separator may be adjusted in any manner known in the art. According to a first preferred method, said power may be adjusted by acting on the temperature of said heat transfer fluid. In this way the thermal difference between the process fluid and the heat transfer fluid, and therefore the power exchanged, is in fact varied.

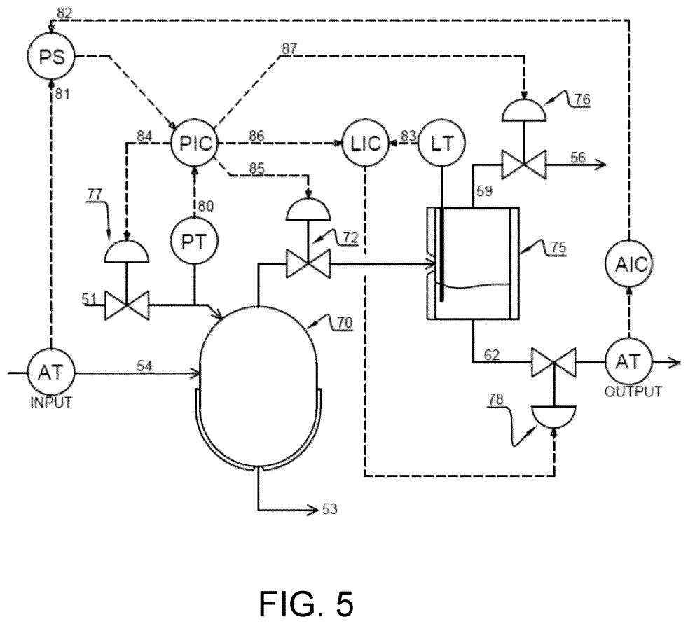

According to a second preferred method, said power may be adjusted by acting on the flow rate of the heat transfer fluid. According to a third preferred method, said power may be adjusted by acting on the level of the heat transfer fluid in the jacket. If said condensation separator is a flooding condenser, according to a further preferred method the power of the condensation separator is regulated by varying the depth of the liquid phase produced. The latter mode is exemplified in FIG. 5, where a flood-type condensation separator (75) equipped with a level sensor (LT) and a system of level control by modulating the opening of valve (78) at the condensates outlet (62) is shown.

With reference to said figure, the pyrolysis reactor (70) receives the substantially plastics material (54) at its inlet and optionally an auxiliary gaseous fluid (51), producing a solid residue (53) and pyrolysis vapours directed towards the at least one condensation separator (75). Optional regulating valve (72) receives the pyrolysis vapours from said pyrolysis reactor (70) and sends them to a condensation separator (75). Opening is regulated by signal (85).

The condensation separator (75) in FIG. 5 is a flooding condenser: the condensed fluid floods the lower part of the condenser and condensation is carried out by passing a heat transfer fluid, colder than the pyrolysis vapours, into a jacket or coil positioned so that the part of the jacket in contact with the vapours to be condensed varies depending on the level of the condensed liquid (for example, by applying the jacket to the side wall of said condenser).

Optional regulating valve (76) regulates the pressure by restricting the cross-section for passage of the residual gas (59) before sending it (56) to the receiving unit.

Optional regulating valve (78) regulates the outflow of the condensed fluid (62) and therefore the flooding level of the flooding condenser (75).

Optional regulating valve (77) regulates the flow rate of the auxiliary gaseous fluid entering pyrolysis reactor (70).

The level controller (LIC) reads the level signal

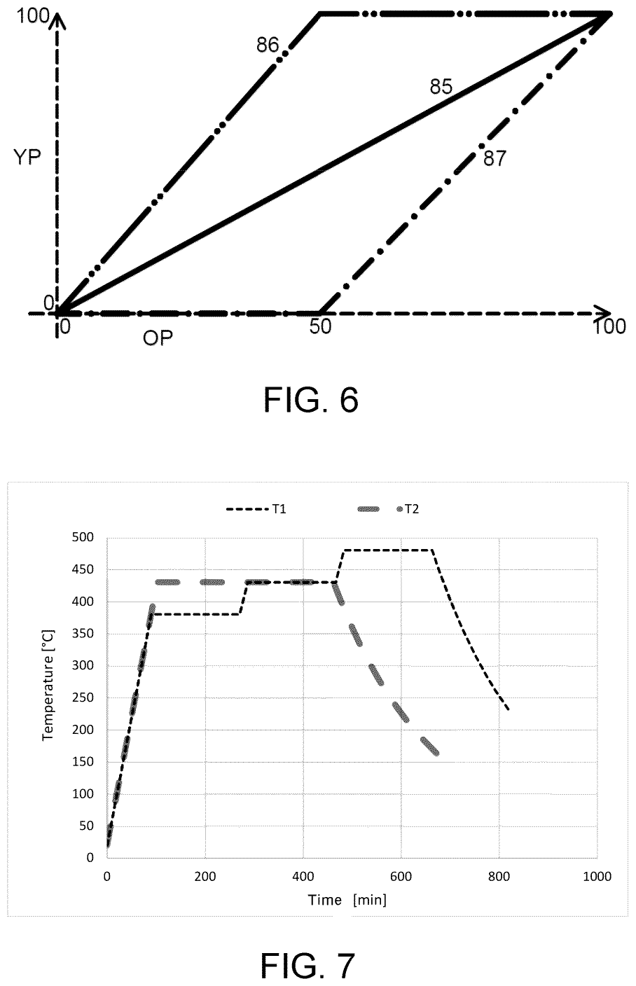

(83) in the flooding condenser (75) measured by the level sensor (LT), and through feedback adjusts the opening of valve (78) to ensure that level (83) corresponds to the set point indication (86) received from the PIC controller. For consistency with what is indicated in FIG. 6, and for congruity with the concept of cooling power, it should be noted that said set point indication (86) is equal to 0 for 100% level (i.e. maximum flooding=minimum condensing power) and 100 for level 0% (i.e. empty condenser=maximum condensing power).

Again, for consistency with what is indicated in FIG. 6, the opening indication (87) sent to valve (76) is equal to 0 for closed valve and 100 for fully open valve.

The opening indication (84) sent to valve (77) operates in reverse mode, because valve (77) must open to increase the pressure of reactor (80) and close to decrease it.

The pressure signal from pyrolysis reactor (80) may be the result of the processing of several pressure transducers, as explained below; moreover, as shown in the figure and explained below, it may be detected on a clean fluid sent to the pyrolysis reactor, near the outlet towards said reactor, so that the membrane of the transducer remains clean. The figure shows the case in which said pressure signal is taken from the conduit which carries the auxiliary gaseous fluid (51) to the pyrolysis reactor.

The pyrolysis reactor pressure set point (PS) may be set locally, i.e. manually, for example by setting the value on the plant control panel, or it may be set remotely, i.e. from an external setting signal.

Said external signal may be for example a set point (81) calculated on the basis of one or more parameters read on the substantially plastics material arriving at the pyrolysis reactor (54). For example, said pressure set point may be an expression in which the variables are the H/C index (H/C index) and the carbon index (carbon index) of said substantially plastics material, measured by an analyser (AT INPUT) in-line, on-line or off-line.

Alternatively, said external signal may be a set point (82) calculated by the feedback controller (AIC) which adjusts said set point (82) so that a parameter representative of the quality of the product in the liquid state obtained after condensation (62), measured from the analyser (AT OUTPUT) on-line (“in-line”), on-line (“on-line”) or off-line, reaches the target value.

The pressure controller (PIC) reads said pressure signal (80) and compares it with the set point (PS), and acts individually on one of the regulating devices (84, 85, 86, 87) or in combination, for example using a PID algorithm (proportional, integrative, derivative) through feedback, in order to minimise the error between the signal read (80) and the set point (PS). One example of an embodiment of said combination is obtained by using regulating devices (86) and (87) in split-range mode, as better explained below.

Referring to the graph in FIG. 6, and in the light of the diagram in FIG. 5, the OP (operating point) determined by the controller (PIC) is shown on the abscissa, which for example may be the output of said controller to the PID algorithm, calculated on the basis of the difference between the pressure signal (80) detected and the set point (SP): OP=0 to bring the pressure to the maximum, OP=100 to bring it to the minimum. The ordinate shows YP, that is the signal sent to the regulating device (for example, those indicated with 84, 85, 86, 87 in FIG. 5).

According to one embodiment, a regulating device, when operated individually, has a linear signal YP with respect to the OP calculated by the PIC. For example, the pressure regulation valve for the pyrolysis vapours leaving the reactor (72) may receive the opening value YP (85) which is equal to 0 for OP=0 (in order to increase the pressure in said pyrolysis reactor) and 100 for OP=100 (in order to reduce the pressure to the maximum). The corresponding curve in FIG. 6 is thick line 85. As a further example, the auxiliary gaseous fluid pressure regulation valve (77) typically receives an inverse signal, i.e. equal to 0 for OP=100 and equal to 100 for OP=0 (curve not represented in FIG. 6 to maintain clarity in the same).

According to an alternative embodiment illustrated in FIG. 6 (“split-range” control mode), again to be read in the light of the diagram in FIG. 5, it uses the level controller (LIC) in combination, by means of the signal (86), with valve (76) whose opening is controlled by signal (87). For OP values between 0 and 50, signal (87) sent to valve (76) is kept at 0 (valve kept closed or at a pre-set minimum opening value, for example 10%), while the signal for the level in the condenser (86) is varied. For example signal (86) may be set to 0 (condensate level in the flooding condenser at the maximum value) for OP=0 and 100 (condensate level in the flooding condenser at the minimum value) for OP=50, and varied linearly between these two values. In this way the pressure is varied by varying the power of the condenser. For OP values between 50 and 100, signal (86) is kept at the maximum level, progressively varying signal (87) for the opening of valve (76). In this way, the pressure of the pyrolysis reactor is regulated by varying the power of the condenser (as described in more detail below), but if this is not enough, the condenser is kept at maximum power and the pressure is adjusted by varying the opening of pressure regulation valve (76) for the residual gas (59). In relatively stationary conditions, the pyrolysis process generally produces incondensable gases, so if the adjustment is made in this mode, the OP value remains between 50 and 100, operating the condenser at maximum power while modulating the pressure regulation valve (76) instead. During the transients of starting, stopping or a strong variation of conditions (for example, due to changes in the substantially plastics material fed) there may be a reduction in the production of vapours, with a consequent reduction in the OP value, even below 50, and therefore in the condensation of vapours. In this way it is possible to maintain the target pressure even during transients. This makes it possible to maximise the efficiency of the process, that is, guaranteeing optimal pressure control and at the same time limiting the flow rate of the residual gas. The split-range mode is therefore generally one of the best ways of regulating pressure during pyrolysis since, given slightly greater complexity of the regulating system, it also allows these transients to be managed effectively.

These methods may be used individually or, possibly, in combination.

By residual gas is meant the fluid comprising hydrocarbons which has not been condensed after passing through said at least one condensation separator. Said residual gas preferably contains at least 40% by weight of light hydrocarbons (C1-C5) with respect to the total weight of said residual gas, and may advantageously be used as a fuel gas. Some of said gas may be recycled in the pyrolysis reactor (after pressurisation) as an auxiliary gaseous fluid, as better specified below; or burnt to supply the thermal energy necessary for the pyrolysis process. For this purpose, for example, a gas heater which regulates the temperature of the heat transfer fluid circulating in the reactor jacket may for example be used. Alternatively or in combination, this residual gas may advantageously be used to feed refinery plants, such as for example a cracking plant.

According to the invention, the fluid which is in the liquid state after condensation in said at least one condensation separator is quantitatively at least 10% by mass, preferably between 20% and 92%, even more preferably between 30% and 85%, even more preferably between 40% and 75%, with respect to the mass of substantially plastics material fed. If more than one condensation separator is used, said quantity is calculated by adding together the quantity by mass of liquid produced by each condensation separator.

According to a preferred method, said at least one condensation separator through which the pyrolysis vapours produced by the pyrolysis reactor are made to pass consists of at least two condensation separators. In this mode, the at least two condensation separators are placed in series. Each condensation separator receives the uncondensed gas leaving the previous condensation separator, while the first condensation separator receives the pyrolysis vapours.

In this preferred mode, the condensation separator which receives the pyrolysis vapours (the first condensation separator) operates at a higher temperature than the second condensation separator which receives the uncondensed vapours from the first condensation separator. According to a further embodiment, if there are several condensation separators in series, each condensation separator that receives the vapours from a (previous) condensation separator operates at a lower temperature than said previous condensation separator.

According to one embodiment, there are three condensation separators and preferably at least the first consists of a distillation column.

If there are at least three condensation separators, preferably the temperature of the liquid effluent of the third last condensation separator is in the range from 220 to 420° C., preferably from 240 to 370° C., even more preferably from 250 to 340° C.

If there are at least two condensation separators, the temperature of the liquid effluent in the penultimate condensation separator is in the range from 100 to 320° C., preferably from 120 to 260° C., even more preferably from 140 to 220° C.

If there is at least one condensation separator, the temperature of the liquid effluent in the last condensation separator is in the range from −10 to 150° C., preferably from 25 to 100° C., even more preferably from 30 to 70° C.

Generally, the best results are obtained by using three condensation separators in series, having the temperatures in the indicated ranges.

According to a preferred method, some of the fluid in the liquid state condensed in at least one condensation separator is sent for recycling to the pyrolysis reactor. Preferably, the fluid recycled to the reactor is taken from the first condensation separator. Preferably, the condensed fluid recycled to the reactor is from 2% to 60% by weight, more preferably from 5% to 30% by weight, with respect to the weight of the pyrolysis vapours produced. In one embodiment, the condensed fluid that is to be recycled to the reactor is heated before being recycled.

The process for the pyrolysis of substantially plastics material to obtain at least liquid hydrocarbons that are in the liquid state at 25° C. according to the present invention can therefore preferably also comprise the following step f):
f) recycling some of the fluid in the liquid state comprising liquid hydrocarbons that are in the liquid state at 25° C. condensed in step e) in said pyrolysis reactor.

In order to facilitate pressure regulation, the Applicant has discovered that it can be advantageous to provide for the introduction into the reactor of a fluid in a gaseous state which will be defined hereinafter as an auxiliary gaseous fluid.

Said auxiliary gaseous fluid may be fed to the pyrolysis reactor, or fed to an apparatus in fluid connection therewith. (for example, said preheating apparatus).

Furthermore, it has been observed that the feeding of a fluid in the gaseous state makes starting up the plant simpler and faster.

If provided, said auxiliary gaseous fluid preferably has a mass flow rate from 1% to 50% of the pyrolysis vapour flow rate, even more preferably from 2% to 30% of the pyrolysis vapour flow rate, in particular from 3% to 20% of the pyrolysis vapour flow rate.

In particular embodiments, said auxiliary gaseous fluid comprises inert gas in the reaction conditions of the pyrolysis. Such inert gas preferably consists of nitrogen, carbon dioxide, water vapor argon and relative mixtures.

In preferred embodiments, said auxiliary gaseous fluid also comprises in combination or alternatively also natural gas and/or other light hydrocarbons. Particularly preferred is methane, or C1-C2, C1-C2-C3 or C1-C2-C3-C4 mixtures (where the number represents the number of carbon atoms). Advantageously, by using an auxiliary gaseous fluid comprising natural gas and/or other light hydrocarbons, the residual gas after the condensation of liquid hydrocarbons that are in the liquid state at 25° C. is more easily usable and/or saleable as a fuel gas, or as a gas feeding to cracking plants.

In particular embodiments, said auxiliary gaseous fluid in combination or as an alternative comprises some of the residual gas (i.e., as defined above, the gas as obtained after passage of the pyrolysis vapours through at least one condensation separator), which as already reported includes a high quantity of hydrocarbons.

In particular embodiments, said auxiliary gaseous fluid in combination or as an alternative comprises water vapour. In fact, it has been surprisingly discovered that the use of water vapour contributes to the reduction of fouling, in particular in the points of the reactor where there is less flow.

Furthermore, the water vapour is easily condensed and separated from the liquid hydrocarbons that are in the liquid state at 25° C. condensed downstream of the pyrolysis reactor, and therefore facilitates the start-up and regulation of the pressure of the plant, at the same time avoiding the residual gas after condensation from being diluted by the water vapour itself. This facilitates its use and/or sale as fuel gas and/or feed to cracking plants.

Process for the pyrolysis of substantially plastics material to obtain at least liquid hydrocarbons that are in the liquid state at 25° C. is therefore a preferred method according to the invention, also comprising the following step a2):
a2) feeding an auxiliary gaseous fluid to a pyrolysis reactor.

Said auxiliary gaseous fluid, as already described above, preferably comprises an inert gas (preferably nitrogen, carbon dioxide, argon, water vapor and relative mixtures), natural gas and/or other light hydrocarbons (preferably methane, C1-C2, C1-C2-C3 or C1-C2-C3-C4 mixtures), residual gas and relative mixtures.

Any technique known in the art can be used to regulate the pressure in said pyrolysis reactor in relation to the composition of said substantially plastics material and/or of the products of said pyrolysis process. According to a first method, the pressure is regulated by regulating the heat extracted from the condensation separator located downstream of the reactor and in fluid connection therewith. In this mode, increasing the heat removed from the condensation separator results in greater condensation of the vapours. This greater condensation brings a greater amount of pyrolysis vapours from the gaseous to the liquid state. The liquid state of a substance typically has a much greater density than the gaseous state. Therefore this greater condensation leads to a reduction in the overall volume occupied by the sum of the liquid and gaseous phases. Since said volume is the physical volume of the equipment in which said fluid is contained, and cannot decrease, there is a reduction in pressure. The lower pressure in fact corresponds to a lower density of the vapours, and therefore allows the liquid phase and the gaseous phase to occupy the volume of the equipment. Conversely, by reducing the heat removed from the condensation separator, and therefore the condensate flow rate, there will be an accumulation of vapours and therefore an increase in pressure.

Any method known in the art may be used to adjust the power of the condensation separator. For example, the flow rate, level or temperature of the heat transfer fluid flowing in the condensation separator jacket may be varied, as previously described.

In this mode, the possible presence of large quantities of incondensable gases in the vapours, such as nitrogen, can make control difficult, as they inhibit condensation.

It may be therefore advantageous to remove the incondensable gases before or during the pyrolysis operation. One way to eliminate incondensable gases is to use any system for the removal of gas, which can then be treated or burned. This system may comprise a valve for regulating the flow rate of the extracted gas and, if the pressure of the pyrolysis reactor is not higher than atmospheric pressure, also a vacuum pump or other device suitable for increasing the pressure of said gas. Optionally, distillation columns may also be provided in order to condense the condensable hydrocarbon fractions, or alternatively or in combination the gas stream extracted from the condensed liquid may be contacted.

In a preferred way, said removal of the incondensable gases takes place by means of removal of the residual gas produced as described in the present invention and exemplified in FIG. 4 in stream (59).

Incondensable gases, including the auxiliary gas possibly used for pressurisation, can be sent to a thermal oxidation system before being released into the atmosphere.

According to a second pressure regulation mode, the pressure is regulated by regulating the flow rate of said auxiliary gas. By way of example, with reference to FIG. 5, this can be achieved by means of a pressure regulation valve (77) which adjusts the flow rate of said auxiliary gas (51) at the inlet to the pyrolysis reactor (70) on the basis of signal (84).

Advantageously, the two methods described above can be combined and used together.

According to a third pressure regulation mode, hereinafter defined as the pressure regulation mode of controlling the pyrolysis vapours, the pressure is regulated by adjusting the opening of a valve through which the pyrolysis vapours pass before entering said at least one condensation separator. By way of example, and again with reference to FIG. 5, this regulation takes place by means of signal (85) sent to valve (72).

In this mode valves that allow softer control (smooth) of the flow as the position of the actuator varies are particularly advantageous. This can make process control more stable, especially on plant start-up when the production of pyrolysis vapours is initially very small but can grow very quickly. Vee-Ball valves can be used for this purpose.

In the pressure regulation mode of controlling the pyrolysis vapours it is also particularly advantageous to use an auxiliary gas which, as already stated, facilitates pressure control.

According to a fourth pressure regulation mode, hereinafter defined as the residual gas pressure regulation control mode, the pressure is regulated by adjusting the opening of a valve through which passes the residual gas, constituted as already mentioned by the fluid comprising hydrocarbons which has not been condensed after passing through said at least one condensation separator. Again by way of example and with reference to FIG. 5, this occurs by modulating signal (87) sent to valve (76) which regulates the flow rate of the residual gas outlet (59).

Advantageously, the two control systems (regulation of the condensation separator power and residual gas pressure regulation) can be combined together. In this combined mode, the pressure regulation system can be advantageously set in “split-range” mode, as previously described: for example, if the regulator output is a variable ranging from 0 to 100, it can be set so that by increasing from 0 to 50 it progressively increases the cooling power to the condensation separator (for example by increasing the flow rate of the liquid that removes the heat from it), while from 50 to 100 it progressively increases opening of the residual gas pressure regulation valve (i.e., for values of 50 or less said valve is kept closed, and then fully opened at 100), keeping the cooling power unchanged.

According to a fifth pressure regulation mode, hereinafter defined as the double pressure regulation control mode, pressure is regulated by combining the pressure regulation mode of controlling the pyrolysis vapours and the residual gas pressure regulation control mode. Also in this case it is advantageous to feed an auxiliary gas according to the methods indicated above.

According to said fifth pressure regulation mode, it is possible to set not only the pressure of the pyrolysis reactor, but also the pressure of the at least one condensation separator located downstream thereof. In this way it is possible to independently regulate the pressure in the pyrolysis reactor and that in condensation. This makes it possible to maintain the pressure of the reactor according to the teachings of the present invention, and at the same time to regulate the pressure of condensation to maximise the yield towards the desired products.

The pressure regulation modes described all allow dynamic regulation of the set pressure value. It is therefore possible to change the pressure value of the reactor in a short time. Preferably, the pressure in the pyrolysis reactor is not therefore kept constant, i.e. it is actively operated so that this parameter falls within the desired range, but is not constant, since said desired pressure range is variable. Preferably, said desired range is in the vicinity of the target value, for example in the vicinity of +0.4 bar of the target value (i.e., the pressure falls within said desired range if the value is greater than or equal to the target value minus 0.4 bar, and at the same time is less than or equal to the target value plus 0.4 bar).

The Applicant has also surprisingly discovered that the pressure control modes disclosed in the present invention not only allow dynamic regulation of the pressure, but they are also self-stable. By “self-stable regulation” we mean that, if properly regulated (tuned), the regulator reacts to set point variations, or to variations in uncontrolled variables (such as, for example, a higher/lower production of pyrolysis vapours due to change in the mixture of plastics contained in the substantially plastics material fed into pyrolysis), limiting the amplitude of the oscillation over time.

The object of the present invention is therefore a process for the pyrolysis of substantially plastics material in which the regulation of pressure in the pyrolysis reactor in step d) is carried out in one or more of the following ways:
regulation of the heat extracted from the condensation separator placed downstream of the reactor and in fluid connection with it, preferably by regulating the power of the condensation separator, removal of incondensable gases or their combination;
when an auxiliary gaseous fluid is supplied, adjusting the flow rate of said auxiliary gaseous fluid;
control of pressure regulation of the pyrolysis vapours by adjusting the opening of a valve through which the pyrolysis vapours pass before entering at least one condensation separator;
control of pressure regulation of the residual gas by adjusting the opening of a valve through which passes the residual gas consisting of the fluid comprising hydrocarbons which has not been condensed after passing through at least one condensation separator;
double control of pressure regulation by combination of the control mode for pressure regulation of the pyrolysis vapour and the control mode for pressure regulation of the residual gas.

The pressure in the reactor is preferably kept within a range between atmospheric pressure and 13 bar (a). More preferably, said pressure is kept within a range of between 1.1 and 8 bar (a). Even more preferably, said pressure is kept within a range of between 1.5 and 6 bar (a). Most preferably, said pressure is maintained within a range of between 2.5 and 4 bar (a).

The pressure in the reactor may be measured in any manner known in the art. For example, pressure transducers placed inside the reactor may be used. Alternatively, according to a preferred method, if auxiliary gaseous fluids are used, the pressure sensor may be advantageously located within the auxiliary gaseous fluids injection duct, even more preferably near the reactor inlet. This makes it possible to limit fouling of the sensor, as it remains in contact with the auxiliary gaseous fluids which are not fouling, and at the same time makes it possible to measure the pressure in the reactor since the sensor is located near the entrance to the reactor: if said duct has a sufficiently large cross-section (generally, even only from 1/100 to 1/10 of the reactor diameter) the kinetic losses of the gases that come out of the duct into the reactor are negligible, so that the pressure measured in the duct substantially coincides with the pressure in the reactor. In order to have a more precise measurement of the pressure, and greater reliability, it is also possible to use more pressure sensors. According to one embodiment, if at least n measuring elements where n≥3 are installed, and as the pressure in the reactor is considered to be the average for the n−1 elements with the smallest difference in measurement.

Advantageously, said pressure regulation is carried out by means of a controller able to read said pressure value, compare said pressure value with the set value (set point), and act, through feedback (feedback), or with forward control (feed forward) or with a composition of these two actions (feedback+feed forward), on at least one parameter of at least one plant element (such as those already disclosed previously) in order to bring the difference between said two values to zero or in any case, in absolute value, to no more than a fixed value, for example 0.4 bar. Any process controller, such as a PID logic controller, fuzzy logic, particle swarm optimisation (PSO) or neural networks, or a combination thereof such as an integrated PID controller with a fuzzy logic controller may be used for this purpose.

Preferably, said regulation is carried out using a PID (proportional, integrative, derivative) algorithm in positional (position PID) or velocity (velocity PID) form.

Typically, when the pressure set point is changed, the regulation mechanism disclosed above allows the new set point to be reached in a short time. However, it may be preferable to avoid rapid pressure changes to avoid entrainment, fouling and instability in the pyrolysis process. Preferably the ratio between the variation in the pressure set point with respect to the time for reaching the new set point is greater than 0.1 bar/hour, more preferably between 1 and 120 bar/hour.

Typically when the pressure set point varies, the change in the operating point (OP) is substantially temporary, i.e. there is a progressive change in the controller's operating point, but after a time essentially determined by the inertia of the system and by the constants of the regulator the operating point returns close to the operating point prior to said variation, even if at the same time the pressure variation is not transitory (of course, unless the set point is brought back to the initial value).

For example, if the quantity regulated by said regulator is the power of the condensation separator, an increase in the set point pressure leads to a reduction in the power of said condensation separator (for example, if said condensation separator is a flooding condenser, raising the level of condensate present in it). This causes an increase in pressure because, as already explained above, a smaller amount of steam is condensed. However, once the target pressure has been reached, the regulator will spontaneously bring the operating point first below, and then close to the value prior to the change. In fact, if the flow rate of the pyrolysis vapours does not vary, the time average of the condenser power also cannot vary.

The pyrolysis pressure set point may also be changed manually. Preferably, said set value is varied automatically, in feedback or feed forward, on the basis of the quality of the liquid product obtained at 25° C. or on the basis of suitable characteristic indices of the substantially plastics material used, as already discussed.

Preferably the liquid product at 25° C. condensed by said pyrolysis vapours (i.e. the pyrolysis oil) obtained by the present invention has a C5-C12 fraction of at least 35%, and at the same time a C21 and higher fraction (hereinafter mentioned as: “C21+”) of more than 3.5%.

Preferably the yield of C5-C12 obtained by the present invention is at least 30% while the yield of C21 and above is at most 3%.

The applicants for the present invention have observed that it is advantageous to define an Overall Index (hereinafter also mentioned as “Overall Index” abbreviated “O.I.”). Said index is defined as the carbon index (C.I.) multiplied by the H/C index, as defined in the present invention, divided by 10000:

$$O . I . = \frac{[ C . I . ] \cdot [ H / C idx ]}{10000}$$

According to one embodiment of the present invention, the pressure in the pyrolysis reactor is regulated in relation to the H/C index and/or the carbon index (C.I.) of said substantially plastics material.

According to a preferred method in said embodiment of the present invention, the pyrolysis process is carried out at a pressure of at least the threshold pressure PS when said “Overall index” O.I. is greater than or equal to 0.7, and at a pressure lower than said threshold pressure PS when the O.I. Overall Index is less than 0.7. Preferably said threshold pressure PS is at least 1.5 bar (a), even more preferably between 2 and 2.9 bar (a), in particular 2.5 bar (a). Generally, in the case in which the substantially plastics material is of an inconstant composition, this method allows the best results to be achieved.

In fact, by applying this criterion in the examples 1 to 11 of the patent, a C5-C12 yield of at least 30% and at the same time a C21 and higher (C21+) yield of more than 3% were obtained. Furthermore, the C5-C12 fraction was also over 30% and the C21+ fraction was more than 3%.

Preferably, the pyrolysis oil obtained from the process according to the present invention is a mixture comprising hydrocarbons in quantities greater than 90% by weight with respect to the total weight of the mixture.

Advantageously, the pyrolysis process according to the present invention produces a particularly useful product such as virgin naphtha that is particularly suitable for steam cracking for the production of monomers of industrial interest, that is, usable in the synthesis of polymers. This allows the plastics to be recycled an indefinite number of times (“closed loop recycling”), as already discussed among the advantages of the present invention.

Advantageously, the process that is the object of the present invention may also be applied to substantially plastics material which does not comprise polymers containing oxygen atoms, as will be evident from the examples. In one embodiment, the substantially plastics material entering the pyrolysis reactor has a mass of oxygen atoms between 0.05% and 18% of the total mass of said substantially plastics material fed, preferably between 0.5% and 12%, more preferably between 1.1% and 8%.

In fact, when the material entering the pyrolysis reactor contains polymers that include oxygen atoms, in particular within the indicated ranges, it has been observed that the pyrolysis oil obtained by applying the process according to the present invention contains optimum quantities of tetrahydrofuran (THF).

Advantageously, the tetrahydrofuran in the pyrolysis oil produced has solvent properties which reduce fouling in the processes in which the pyrolysis oil produced is used. In this way, for example, it is possible to reduce the cleaning downtimes for plants that use said pyrolysis oil, for example by enabling a 10% reduction in the downtimes for a steam cracking plant that uses called pyrolysis oil.

As will be evident from the examples described, the process according to the present invention makes it possible to increase the tetrahydrofuran content in comparison with conventional processes, in particular by obtaining a pyrolysis oil with optimum quantities of tetrahydrofuran with respect to the aforementioned objective.

Advantageously, the pyrolysis oil according to the present invention preferably has a tetrahydrofuran (THF) content of between 0.01% and 0.25%, preferably between 0.07 and 0.19%, with respect to the total weight of the pyrolysis oil.

It has also been surprisingly discovered that the pyrolysis oil obtained from the process according to the present invention is characterised by low quantities of benzoic acid.

In large quantities, benzoic acid is in fact generally harmful in the processes using pyrolysis oil as it releases acidity, and is produced in large quantities when the substantially plastics material fed to the process contains high quantities of non-vinyl polymers such as polyethylene terephthalate (PET).

In the state of the art various processes have been proposed both for recovering benzoic acid downstream of pyrolysis, and for reducing its production via catalytic conversion (see e.g. Shouchen Du et al., “Conversion of Polyethylene terephthalate based waste carpet to benzene-rich oil through thermal catalytic and catalytic steam pyrolysis”, ACS Sustainable Chem. Eng. 2016, 4, 5, 2852-2860 Apr. 11, 2016, doi https://doi.org/10.1021/acssuschemeng.6b00450).

Conversely, the process according to the present invention makes it possible to avoid such benzoic acid recovery processes, providing a pyrolysis oil which already comprises low quantities of benzoic acid.

Advantageously, the pyrolysis oil according to the present invention has a benzoic acid content of not more than 2%, preferably between 0.01 and 1%, with respect to the total weight of the pyrolysis oil.

It has also surprisingly been found that the process according to the present invention is characterised by a low production of some non-linear alkenes.

It is known that alkenes are generally not desirable in pyrolysis oil as they favour fouling and reduce the quality of the naphtha, measured for example using the PONA or PIONA indices.

Advantageously, the pyrolysis oil that is the object of the present invention is characterised by an isobutene content (IUPAC name 2-methylpropene) of not more than 0.55%, preferably between 0.15 and 0.3%, with respect to the total weight of the pyrolysis oil.

According to a first modality, preferably the process for the pyrolysis of substantially plastics material is characterised in that the pressure is regulated on the basis of the composition of said substantially plastics material.

The composition of said substantially plastics material can be analysed using in-line, on-line or off-line methods. Among the off-line methods, all analytical techniques known in the art may be used. In particular, if it is of interest to calculate the H/C index and the carbon index, it will be sufficient to evaluate the total quantity of carbon and hydrogen included in the substantially plastics material. For this purpose, for example, it is possible to use an elemental analyser which provides for complete combustion of the sample followed by analysis of the gases produced by gas chromatography, thermal conductivity, infra-red spectroscopy or a combination of these techniques.

Among the in-line or on-line methods, in particular automated sampling systems coupled to gas chromatographs, gas chromatographs coupled to mass spectrometers or measurement systems in the near infra-red (NIR) may be used.

According to a different modality, the process for the pyrolysis of substantially plastics material is characterised by the fact that said pressure is regulated on the basis of characteristic parameters defined by the composition and/or by the production yield of said fluid comprising liquid hydrocarbons that are in the liquid state at 25° C. and/or characteristic parameters thereof.

The composition of the pyrolysis oil can be determined by in-line, on-line or off-line methods. Among the in-line or on-line methods, in particular automated sampling systems coupled to gas chromatographs or measurement systems in the near infra-red (NIR) may be used. According to the present invention, the pressure in said pyrolysis reactor is regulated as a function of characteristic parameters defined by the composition of said substantially plastics material and/or characteristic parameters defined by the products of said pyrolysis process, while at the same time maintaining said pressure at a value between atmospheric pressure and 13 bar (a).

Preferably, if the pressure is regulated in relation to characteristic parameters defined by the products of said pyrolysis process, said products are those made in step c) and/or e) of the process for the pyrolysis of substantially plastics material according to the present invention. According to one embodiment, said characteristic parameters defined by the composition of said substantially plastics material are the H/C index (H/C index) and/or the carbon index (carbon index) of said substantially plastics material.

According to one embodiment, said products of said pyrolysis process in which said characteristic parameters are defined are the pyrolysis oil obtained by condensation of the effluent in the gaseous state produced by the reactor in step c) and/or a fluid comprising liquid hydrocarbons that are in the liquid state at 25° C. obtained from the condensation mentioned in step e).

According to one embodiment, said characteristic parameters defined by the products of said pyrolysis process are their production yield and/or a characteristic measured on them, in particular the refractive index, viscosity, molecular weight and relative combinations.

According to one embodiment, the process for the pyrolysis of substantially plastics material is characterised in that the pressure is not constant. Preferably, said inconstant pressure is temporally inconstant, spatially inconstant, or spatially and temporally inconstant.

Pressure that is not temporally constant means that the pressure has varied over the time domain. Preferably, according to this method, the temporal variation is at least 0.2 bar per day, even more preferably between 0.5 and 15 bar per hour, even more preferably between 1 and 5 bar per hour.

By spatially inconstant pressure is meant that the pressure has varied in the space domain, i.e. by maintaining different zones of the reactor at different pressures. For example, there may be a first zone of the reactor (where the substantially plastics material is received) at a particular pressure, in which said substantially plastics material is heated and held at a first pressure for a first residence time, and a second zone where said substantially plastics material, already partly pyrolysed, is held at a second pressure different from the first for a second residence time.

According to this embodiment, the pressure difference between one zone and the next is preferably positive, i.e. the next zone has a lower pressure than the previous zone. Preferably the pressure difference between one zone and the next is at least 0.1 bar, more preferably from 0.2 bar to 10 bar, even more preferably between 1 and 5 bar, most preferably between 2 and 4 bar.

Preferably the process for the pyrolysis of substantially plastics material is characterised by a time sufficient to produce at least one effluent in the gaseous state, as defined in step c) of the process in said pyrolysis reactor, of at least 30 minutes, preferably 1 hour and 30 minutes to 15 hours, even more preferably from 2 hours and 30 minutes to 9 hours, most preferably from 3 hours 10 to 6 hours.

In the continuous or semi-continuous process, as previously defined, said time, as defined in step c) of the process, is calculated as the ratio between the volume of the reactor not occupied by the gas phase alone and the volume flow fed. By volume flow we mean the flow rate per unit of volume, which for example may be calculated by dividing the mass flow by the density of the substantially plastics material.

The volume of the reactor not occupied by the gas phase alone means the volume calculated by subtracting the volume occupied by the gas phase alone from the geometric volume of the reactor. Therefore, following what has already been indicated above, said reactor volume not occupied by the gaseous phase alone is the volume of the reactor that lies below the “free surface”, i.e. the volume occupied by the substantially non-gaseous phase as defined previously. Therefore, generally said volume thus comprises the liquid phase and the solid phase, plus the developed gas which has not yet reached the free surface or the liquid-gas separation surface.

The pyrolysis reactor may comprise further elements such as at least one agitator and/or other elements such as for example baffles. In this case, the geometric volume of the reactor means the geometric volume of the reactor less the volume of said elements, that is the net volume of the reactor.

If there is no free surface, or if there is no formation of a liquid-gas separation surface (for example, because it cannot be determined or because foam is formed at such a level as to fill the entire reactor), said volume should be considered to be the geometric volume of the reactor.

The volume flow fed is instead the volume flow rate of substantially plastics material that is fed to the reactor, expressed in SI units such as m3/s, and calculated directly (volume fed divided by the period of time in which this volume is fed) or indirectly, for example by measuring the mass flow and dividing it by the density.

In the batch (discontinuous) process on the other hand, said time as defined in step c) is calculated as the holding time of the material in said pyrolysis reactor under the conditions indicated in step c).

In the pyrolysis process according the present invention, said residence time is preferably at least 30 minutes, even more preferably between 45 and 540 minutes, even more preferably between 60 and 360 minutes, even more preferably between 90 and 240 minutes, and particularly preferably between 130 and 210 minutes.

Advantageously, the process f substantially plastics material may be equipped with an automatic regulation and control system for automatically regulating at least the pressure in step c). In addition to said pressure in step c), said automatic regulation and control system may also regulate other process parameters, such as for example the temperature and/or residence time in step c).

Said automatic regulation and control system may acquire one or more process variables, including said pressure in step d). Said process variables may furthermore also include the yield of the process in liquid hydrocarbons that are in the liquid state at 25° C. mentioned in step e).

Alternatively or in combination, said automatic regulation and control system may acquire one or more product variables. Said product variable may be characteristic of the substantially plastics material fed to the process in step a) and may for example be the H/C index or the carbon index.

Alternatively or in combination, said product variable may be characteristic of the effluent in the gaseous state mentioned in step c) and/or said fluid comprising liquid hydrocarbons that are in the liquid state at 25° C. mentioned in step e) and may be chosen from molecular weight, molecular weight distribution, halogen content, content of compounds having from 5 to 12 carbon atoms (C5-C12), content of compounds having at least 21 carbon atoms (C21+) or combinations thereof.

Preferably, the mixture of hydrocarbons obtained from the pyrolysis process disclosed in the present invention contains tetrahydrofuran in an amount between 0.01% and 0.25% by weight, more preferably between 0.07 and 0.19% by weight.

Preferably the process for the pyrolysis of substantially plastics material is integrated with a process for recovery of the plastics material which comprises a sorting plant, so that the pyrolysis process uses as the substantially plastics material fed in step a) the non-recovered fraction as a single polymer.

Preferably, the effluent in the gaseous state produced in step c) may be further treated in a dedicated step c2) before carrying out the partial or total condensation mentioned in step e). Preferably, this further treatment in step c2) consists of bringing said effluent to a temperature between 400 and 650° C., preferably between 440° C. and 550° C., even more preferably between 460° C. and 530° C. and holding said effluent in said temperature interval for a time of at least 10 seconds, preferably between 30 seconds and 6 minutes, even more preferably between 1 and 4 minutes.

Preferably, step c2) is carried out in the presence of a solid catalyst in contact with said effluent in the gaseous state. Even more preferably, said effluent in the gaseous state is in relative movement with respect to said solid catalyst in contact with said effluent in the gaseous state, and said relative movement is at a speed of at least 0.5 m/s, more preferably from 2 to 50 m/s.

According to one embodiment, passage c2) is made at a pressure substantially corresponding to the pressure used in passage c). By substantially corresponding pressure is meant that the difference between the pressure in passage c) and in passage c2) is preferably comprised between zero and 0.5 bar.

According to an alternative embodiment, passage c2) is made at a pressure substantially lower than the pressure used in passage c). Substantially lower pressure means that the difference between the pressure in passage c) and passage c2) is greater than 0.5 bar. To carry out said alternative embodiment, it is possible to place a pressure regulation valve between the pyrolysis reactor and the reactor in which step c2) is carried out. In this embodiment pressure in the pyrolysis reactor may be regulated through said pressure regulation valve.

According to one embodiment, passage c2) is made at atmospheric pressure.

All catalysts known in the art may be used as a solid state catalyst, including in particular zeolites.

The present invention also relates to a reactor for the pyrolysis of substantially plastics material to obtain at least liquid hydrocarbons that are in the liquid state at 25° C. comprising:
i) At least one port (N2) for exit of the gaseous product located on the top of the reactor or at a distance from the top of the reactor not greater than ⅓ of the height of the reactor (H);
ii) At least one port (N3) for extraction of the solid product located at the bottom of the reactor or at a distance from the bottom of the reactor not greater than ⅓ of the height of the reactor (H);
iii) At least one port for the entry of substantially plastics material (N1) at a distance from the top of the reactor (D1) equal to or greater than the distance (D2) between said port for exit of the gaseous product and the top of the reactor; iv) At least one stirrer;
v) At least one jacket for heating the reactor;
vi) At least one temperature transducer,
vii) At least one pressure transducer;
viii) At least one sensor for measuring the reactor level,
characterised by the presence of a separator for carried over material (demister) placed under and/or at said port for exit of the gaseous product. According to an embodiment, said reactor is also characterised by a design pressure of at least 2 bar absolute and a design temperature of at least 450° C. According to one embodiment, said reactor is also characterised by a concave volume equal to more than 10% of the total volume of the reactor.

This reactor may be advantageously used to carry out the steps from a) to d) of the process according to the present invention.

Normally the reactors for the pyrolysis of substantially plastics material are subject to fouling which reduces their operability. In fact, the fouling is typically constituted by carbon deposits which adhere to the internal surface of the reactor and tend to accumulate. As a result of the accumulation of fouling, it is more difficult to manage the system. Furthermore, it has been observed that fragments of the material constituting the fouling can detach from the internal wall of the reactor and be entrained in the pyrolysis vapours, thus ending up in the condensed pyrolysis oil. It is therefore necessary to interrupt the process, purify the plant, open the reactor and clean it, for example by brushing or hydrojets. Frequent fouling is therefore undesirable because it therefore brings about a reduction in the productivity of the plant.

Furthermore, fouling tends to coat not only the internal surface of the reactor but also the temperature, pressure and level sensors, thus causing a reduction in their effectiveness.

This reduction in effectiveness is particularly critical for the pressure sensor, because according to the present invention the reactor pressure is regulated and therefore incorrect measurement of the reactor pressure may jeopardize the results.

Finally, it has been observed that fouling is also favoured by pressure variations if they carried out quickly. While not pretending to provide an explanation for the phenomenon, it is possible that said fast pressure variations cause fouling because during a fast depressurisation the volume of the gas in the bubbles included in the substantially non-gaseous phase increases, and furthermore part of the liquid present in it could vaporise. Foaming can therefore occur, after which the liquid, molten and solid material present wets parts of the reactor normally in contact with the gaseous phase only. During a subsequent pressurisation stage, or through simple stabilisation, the foam is reduced but part of the reactor surface remains wetted by said liquids, melts and solids, which, unlike the lower part of the reactor wetted by the substantially non-gaseous phase, cannot be removed or replaced by other material as they remain in contact with the gaseous phase only.

It has been observed that the reactor for the pyrolysis of substantially plastics material to obtain at least liquid hydrocarbons that are in the liquid state at 25° C. including the features mentioned above surprisingly makes it possible to reduce fouling even when the pyrolysis pressure is varied during the process of pyrolysis, or according to the methods indicated in the present invention.

In particular, it has been observed that the position of the ports as indicated, together with a substantially convex profile are important characteristics for achieving the aforementioned result, as also shown by the examples in the present invention.

Said reactor further comprises a demister placed under and/or at said port for exit of the gaseous product.

The demister makes it possible to avoid carrying the substantially plastics material and the liquids obtained from partial pyrolysis thereof over together with the pyrolysis vapours.

Furthermore, it has been discovered that the demister makes it possible to hold back the liquid formed during the pressure change. In fact, the process according to the present invention is characterised by an inconstant pressure. When the pressure is increased, for example following variation in the nature of the substantially plastics material at the reactor inlet or through feedback with respect to the viscosity, refractive index or molecular weight of the liquid hydrocarbon produced at 25° C., the sudden formation of liquid droplets may occur. The demister therefore makes it possible to reduce the quantity of said droplets entrained together with the pyrolysis vapours.

Conversely, when the pressure is reduced quickly, boiling may occur within the liquid contained in the pyrolysis reactor. This sudden boiling may temporarily increase the level in the reactor, as the gas bubbles formed take some time to reach the surface of the reactor, especially if the liquid phase is viscous as it includes the polymer being pyrolysed. This level may rise to the point of filling the entire pyrolysis reactor. In this case, the fluid in the liquid state that contains the polymer being pyrolysed may reach the outlet nozzle for the vapours and be drawn over, with consequent deleterious fouling as well as malfunctioning of the pressure control equipment and systems.

It has therefore been found that a demister can facilitate not only agglomeration of the drops of liquid in a gaseous stream, but also the separation of a gaseous phase incorporated in a liquid, thus preventing the liquid phase from being drawn over together with the gaseous phase at the outlet for the vapours of pyrolysis.

According to a preferred method, several pyrolysis reactors may be used to carry out the steps from a) to d) of the process according to the present invention, the pyrolysis vapours from which are fed to a single secondary reactor which carries out step c2) described above. In this mode, the vapours of the pyrolysis reactors may be pooled before entering said secondary reactor, or enter through separate outlets. Advantageously, an interception valve may be interposed on each of the pyrolysis vapours leaving each pyrolysis reactor, so as to allow the plant to be operated even during maintenance, malfunction and/or operations of loading the substantially plastics material and/or discharge of the solid residue in one of the pyrolysis reactors.

### Preferred Modes of the Reactor According to the Invention

According to a preferred method, the height (DJ) corresponding to the distance of the highest point of the reactor body heated by the jacket from the top of the reactor is equal to or greater than the distance (D1) between the port for entry of the substantially plastics material and the top of the reactor.

The “highest point” of the reactor body heated by the jacket means the highest point of the reactor body which is in contact with the heat transfer fluid that circulates in said jacket, as illustrated in FIG. 1.

Preferably, the jacket for heating the reactor has a minimum distance from the top of the reactor of more than ⅓ of the height of the reactor.

Preferably, said reactor heating jacket comprises septa to favour uniform distribution of the heat transfer fluid which circulates inside it. Alternatively, said reactor heating jacket is a coil made with a tube wound around the reactor wall. According to a further modality, said reactor heating jacket is a coil made with a half pipe (i.e. a pipe cut in half along a plane passing through a diameter of said pipe and perpendicular to the cross-section of the pipe), welded to the reactor wall. This type of jacket is known as a “half-pipe jacket” or “split-coil jacket”.

According to a first method, the inlet for the heat transfer fluid is positioned at the bottom of the jacket and the outlet at the top so as to create a flow from the bottom upwards. This mode favours the outflow of any bubbles included in the heat transfer fluid. Alternatively, the inlet of the heat transfer fluid is positioned at the top of the jacket and the outlet at the bottom, so as to achieve a flow from top to bottom. This mode is particularly useful if molten salts are used as heat transfer fluid, as it means that dedicated pumps need not be used since the heat transfer fluid can flow into the jacket by using the force of gravity. Advantageously, in this case the heat transfer fluid may be at substantially atmospheric pressure.

According to a preferred method, the stirring elements are placed at a distance (DS) from the top of the reactor which is equal to or greater than the distance (D1) between the port for entry of the substantially plastics material and the top of the reactor. By stirring elements we mean the stirring elements which contribute to the stirring effect, that is to the rotational movement around the rotation axis of the substantially non-gaseous phase present in the pyrolysis reactor. The stirring elements may therefore be stirrer blades, but not the stirrer shaft, bushings or other elements which do not contribute to imparting said rotation.

According to a preferred modality, the reactor further comprises:
ix) at least one port for entry of an auxiliary gaseous fluid at a distance from the top of the reactor not greater than ⅓ of the height of the reactor and/or
x) at least one port for entry of a liquid fluid condensed in at least one condensation separator and recycled in the reactor, located at a distance from the top of the reactor not greater than ⅓ of the height of the reactor. Particularly preferred is a reactor which comprises x) at least one port for entry of said liquid condensed fluid into at least one condensation separator.

According to a preferred embodiment, the reactor comprises at least one system for regulating the pressure in said reactor in relation to one or more characteristic parameters of the substantially plastics material fed and/or one or more characteristic parameters of the pyrolysis oil produced by said reactor.

As indicated, the reactor according to the present invention is characterised by the presence of a demister. Any type of demister known in the art may be used. For example, suitable nets may be used, placed on the top of the reactor but under the port for exit of the gaseous product. These nets can be made of metal wire (for example 0.011 inch) intertwined with diagonal folds (“diagonal crimped knitted wire”). Alternatively, in the same position bars may be used which are arranged so as to impinge on the flow of the vapours towards the outlet port for the pyrolysis vapours, according to methods known in the art.

These bars are particularly effective for the liquid-vapour separation action in case of fast depressurisation, as indicated above.

According to one alternative embodiment, the demister may be of the type with compartments with single or double pockets (“single-” or “double-pocket vanes”) with horizontal or vertical flow. Of these types, the vertical flow single pocket system is preferred.

Preferably, said demister consists of a cyclone characterised by being within the reactor and having the gas outlet connected to said port for exit of the vapours from the pyrolysis reactor.

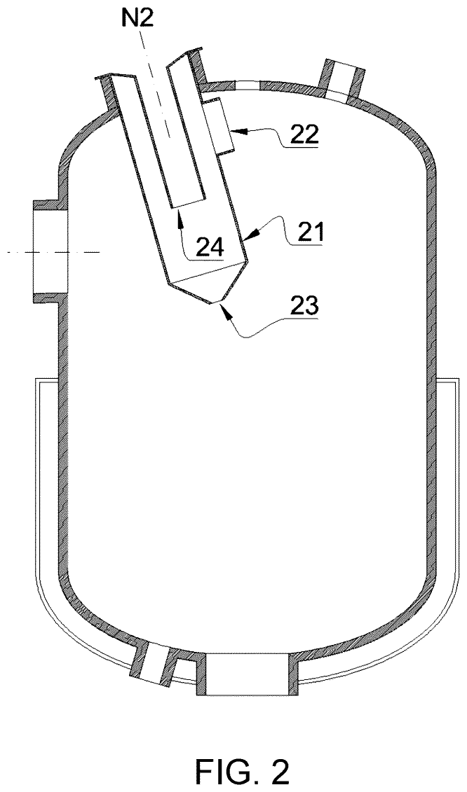

With reference to FIG. 2, said entrainment separator comprises a body (21) with a substantially cylindrical section, equipped with:
a first opening (22) which allows the pyrolysis vapours in which entrained liquid and/or solid masses are possibly present to enter;
a second opening (23) which allows the separated liquid and/or solid to exit;
a sleeve (24) which allows the pyrolysis vapour to escape from the reactor through port (N2).

This cyclone is therefore characterised by an inlet (22), preferably placed off-axis so as to impart a tangential motion to the vapours entering the body of the cyclone (21). The cyclone is equipped with a “vortex finder” equipped with an opening (24) which picks up the pyrolysis vapours and carries them towards the reactor outlet. The cyclone is also equipped with an opening at the bottom (23) which allows the collected liquid to escape, which in this way can fall back into the reactor itself by gravity.

Advantageously, said opening at the bottom (23) is characterised by a passage cross-section equal to no more than 20%, preferably no more than 10%, even more preferably no more than 5%, of the passage cross-section of the inlet (22).

Preferably, said cyclone is entirely included in the first third of the height H of the reactor, i.e. the lower end is at a distance of at most H/3 from the top of the reactor, always measured along the vertical. Among the various demister modes indicated, the cyclone mode generally proved the best as it generates less fouling and is easy to maintain.

There follows a detailed description of the analytical techniques used in the examples for the present invention.

### Method of Gas-Chromatographic Analysis of Pyrolysis Oil Samples

The pyrolysis samples oil were characterised by gas chromatographic analysis. The compounds were first qualitatively identified by means of a coupled gas chromatography mass spectrometry (GC-MS) technique, while they were quantified by gas chromatography with a flame ionization detector (GC-FID).

Below are the instrumental parameters used for the GC-FID analyses:
GC: Agilent HP 7890 B, fitted with Gerstel MPS autosampler
Column: HP-PONA Agilent Technologies J&W-50 m-0.2 mm 0.5 μm,
Carrier (H2): 1.1 mL/min constant flow
Injector: 320° C., 255:1 split, 3 mm (Ultra Inert) liner with glass wool
Detector: 360° C.
Oven: Column temperature program: 20° C. 5 min, in 2° C./min up to 70° C. for 5 min, in 2° C./min at 160° C. for 5 min, in 2° C./min to 320° C. for 30 min (Run time: 195 min).

Each sample was analysed as is by attributing an arbitrary response factor equal to one for all compounds; the concentrations obtained were then normalized to 100%.

### Gas-Chromatographic Analysis Mode on Wax Samples

By wax we mean the fraction left at the bottom after ultracentrifuging of the pyrolysis oil, as described below.

This fraction is analysed in different ways to allow the identification of high molecular weight compounds as well.

In fact, these compounds could plausibly not be eluted and analysed in the gas chromatographic analyses.

Before taking the sample for GPC analysis, the pyrolysis oils contained in Schott bottles were heated to 50° C. to homogenize their contents (in some cases characterised by deposits and/or layers of waxy compounds at room or chilled temperature). A few mg of sample in 1,2,4-trichlorobenzene (Baker) with added 10 μL of n-heptane (internal marker) were dissolved with heating (one hour of dissolution at 150° C.) in order to obtain a concentration of approximately 1.8 mg/mL.

The analyses were carried out on a chromatographic apparatus consisting of:
High temperature Char Polymer GPC-IR
bench of 3 TSK gel HT2 columns of dimension 13 μm and pre-column
IR5 high temperature infra-red detector that provides an absorbency signal proportional to the quantity of methyl and methylene groups.

The experimental conditions adopted were as follows:
eluent: 1, 2, 4 TAB stabilised with BHT
flow: 1 mL/min
temperature: pump at 25° C., injector at 150° C., columns at 150° C., detector at 150° C.
injection volume: 200 microlitres
internal standard: n-heptane.

### Gas-Chromatographic Analysis of the Pyrolysis Gas

The pyrolysis gas effluent samples were sampled in 500 mL Swagelok cylinders of the DOT type (i.e. regulated by the US Department of Transportation-DOT), stainless steel type 304L, internally coated with PTFE to render the internal surface inert. The instrumentation used was an Agilent 490 μGC equipped with 3 modules in parallel, each of which determined only certain types of compounds. In particular:
Module 1:10 m MS 5 Å with heated injector and back flush
Module 2:10 m PPQ with unheated injector
Module 3:10 m CpSil-5CB with heated injector.

Below are the instrumental parameters used for the various modules:
Module 1: T injector: 110° C., Back flush: 30 s injection time: 100 ms, column T: 45° C., Carrier gas pressure: 80 kPa, Carrier gas: Argon (essential for hydrogen analysis).
Module 2: injection time: 15 ms, column T: 70° C., Carrier gas pressure: 180 kPa, Carrier gas: Helium.
Module 3: T Injector: 110° C., injection time: 20 ms, column T: 70° C., Carrier gas pressure: 230 kPa, Carrier gas: helium.

Each module analyses only a few specific compounds:
Module 1: Hydrogen, oxygen, nitrogen, methane, CO.
Module 2: CO2, ethylene, ethane, propylene, propane, propadiene, propyne, i-butane, i-butene, 1-butene, 1,3-butadiene, n-butane, trans-2-butene, cis-2-butene.
Module 3:1-buten-3-yne, 1,2-butadiene, i-pentane, 1,4-pentadiene, 1□pentene, n-pentane, 2-methyl-2-butene, 1,3-pentadiene, cyclopentene, n-hexane, methyl-1,3-cyclopentadiene, benzene, 3-ethylcyclopentene, methylcyclohexane, toluene, ethyl benzene, xylene.

Quantification was carried out by means of a calibration line with an external standard, consisting of two calibration cylinders with the following composition:
Cylinder 1: PENTENE-2 (trans)=0.1 mole %; PENTENE-2 (cis)=0.1 mole %; PENTENE-1=0.1 mole %; PENTANE-n=0.25 mole %; METHYL-2 BUTENE-2=0.2 mole %; ISOPENTANE=0.5 mole %; HEXANE-n=0.1 mole %; PROPYLENE=20 mole %; PROPANE=0.5 mole %; PROPADIENE=0.5 mole %; METHANE=20 mole %; ISOBUTENE=1 mole %; ISOBUTANE=0.5 mole %; HYDROGEN=15 mole %; ETHYLENE=30 mole %; ETHANE=3 mole %; CARBON OXIDE=1 mole %; CARBON DIOXIDE=0.5 mole %; BUTENE-1=1 mole %; BUTENE-2 (trans)=0.5 mole %; BUTENE-2 (cis)=0.5 mole %; BUTANE-n=0.5 mole %; BUTADIENE-1.3=1.5 mole %; ACETYLENE=0.5 mole %; Complement to 100%: NITROGEN. Cylinder volume [litres]: 40; Charging pressure [bar]: 6.29; Cylinder Type: Aluminium.
Cylinder 2: BENZENE=0.0302 mole %; TOLUENE=0.0323 mole %; METHYCYCLOHEXANE=0.0674 mole %; STYRENE=0.0334 mole %; ETHYL BENZENE=0.0339 mole %; Complement to 100%: HELIUM. Cylinder volume [litres]: 5; Charging pressure [bar]: 13.9; Cylinder Type: Aluminium.

The following compounds are not present in the calibration cylinders. The calibration of compounds sufficiently similar to them was therefore used, which have very similar response factors (the difference in this case is negligible):

| Composition: | Calibrated with: |
|---|---|
| propyne | Propadiene |
| 1-buten-3-yne | 1,3-butadiene |
| 1,2-butadiene | 1,3-butadiene |
| 1,3-pentadiene | 1,3-butadiene |
| 1,4-pentadiene | 1,3-butadiene |
| Cyclopentene | 1-pentene |
| Methyl-1,3-cyclopentadiene | 1-pentene |
| 3-methyl-cyclopentene | 1-pentene |

### Thermo-Gravimetric Analysis (TGA) Method on Solid Residue (CHAR)

TGA analysis was performed on a TA Instrument model Q 500 instrument. The temperature calibration was carried out using the Curie Point of Alumel and Nickel samples while the weight calibration was carried out using certified weights supplied by TA Instrument together with the analyser. The sample as is, weighed for quantities between 20-30 mg in a stainless steel sample holder, was placed together with the sample holder on the platinum crucible of the TGA analyser. Use of the stainless steel sample holder facilitates isolation and recovery of the final residue (ash) while preserving the integrity of the platinum crucible. The sample was subjected to an analytical procedure in three stages:
1st stage (pyrolysis in nitrogen atmosphere): starting from an initial temperature of 40° C., the sample was heated at a controlled rate (v=10° C./min) up to 800° C.
2nd stage (cooling in nitrogen atmosphere): starting from an initial temperature of 800° C., the sample was cooled at a controlled rate (v=20° C./min) down to 400° C.
3rd stage (thermal oxidation in air atmosphere): starting from a temperature of 400° C., the sample resulting from pyrolysis (stage 1a) was subjected to heating at a controlled rate (v=20° C./min) up to 850° C.

The integrations were performed using Universal software (TA Instruments), resulting in:
STAGE 1: the weight loss at various temperatures following determination of the temperature corresponding to the maximum peak of the derivative of the weight loss with respect to temperature and the residue at 800° C.
STAGE 3: the weight loss at various temperatures following determination of the temperature corresponding to the maximum peak of the derivative of the weight loss with respect to temperature and the residue at 850° C. For STAGE 3 the weight losses correspond to one or more carbonaceous species differing in allotropic state or particle size.

Some illustrative but non-limiting examples of the present invention follow.

### Method of Determining Ash (Inorganic Residue) on the Substantially Plastics Material

20 grams of substantially plastics material were weighed in a crucible and placed in an oven (Heraeus model K1253, Tmax 1250° C.) held in a flow of nitrogen. The temperature was brought to 400° C. with a 5° C./min ramp and held at 400° C. for an additional hour. Air was then fed instead of nitrogen and the temperature was gradually brought up to 850° C. still with a 5° C./min ramp and held at 850° C. for another hour, then the oven was turned off and left to cool for about 12 hours.

The remaining material is called ash and was weighed. The percentage of ash was calculated as the weight of said residue with respect to the amount of material of the substantially plastics material initially weighed (20 grams).

### EXAMPLES

### Raw Material

It was considered appropriate to use primarily virgin raw material, the composition of which is therefore known and constant, thus also facilitating the repeatability of the invention. By preparing suitable mixes of the raw material, it was therefore possible to evaluate the effect on pyrolysis due to variation in this alone. A substantially non-virgin plastics material was also tested (hereinafter mentioned as “BA1”), that is the residue after selection (“sorting”) of recycled plastics material, of the “Plasmix” type, which was analysed according to what has already been indicated to determine its atomic composition.

The materials used were the following:

| Polymer | Abbreviation | Degree | Producer |
|---|---|---|---|
| Low density | LDPE | Riblene ® FC20 | Versalis |
| polyethylene | | | |
| Low density linear | LLDPE | Flexirene ® CL10 | Versalis |
| polyethylene | | | |
| High density | HDPE | Eraclene ® BC82 | Versalis |
| polyethylene | | | |
| Polypropylene | PP | Isplen ® PP040 | Repsol |
| Polystyrene | PS | Edistir ® N3782 | Versalis |
| Polyethylene | PET | Monflakes ® R-PET | Montello |
| terephthalate | | | |
| Cellulose | CELL | C6288 | Sigma- |
| | | | Aldrich |
| Polyvinyl chloride | PVC | S3160 | Vinnolit |
| Recycled plastics | BA1 | — | — |
| material after | | | |
| “Plasmix” sorting | | | |

The polyethylene granules were mixed in the following ratio: 5.7% of HDPE Eraclene BC82, 34.3% of LLDPE Flexirene CL10 and 60% of Riblene FC20. This mixture is therefore the “PE” material used subsequently.

The following table shows the atomic composition (percentages by weight) of the materials used.

| | | MATERIALS (in abbreviation) | | | | | | |
|---|---|---|---|---|---|---|---|---|
| | | PE | PP | PS | PET | CELL | PVC | BA1 |
| ATOM | H | 14.3% | 14.3% | 7.7% | 4.2% | 6.2% | 4.8% | 12.5% |
| | C | 85.7% | 85.7% | 92.3% | 62.5% | 44.4% | 38.7% | 79.4% |
| | N | 0.0% | 0.0% | 0.0% | 0.0% | 0.0% | 0.0% | 0.2% |
| | O | 0.0% | 0.0% | 0.0% | 33.3% | 49.4% | 0.0% | 3.3% |
| | Cl | 0.0% | 0.0% | 0.0% | 0.0% | 0.0% | 56.5% | 0.4% |

The “BA1” material also showed a residual ash, essentially due to inert inorganic materials, determined using the method described above, equal to about 4% by weight.

The following compounds were prepared using the listed raw materials (parts by weight):

| | MIX | | | | |
|---|---|---|---|---|---|
| | PAT1 | PAT2 | PAT3 | PAT4 | PAT5 |
| PE | 70.00 | 51.60 | 46.60 | 42.10 | 52.58 |
| PP | 30.00 | 22.20 | 20.00 | 18.00 | 22.55 |
| PS | 0.00 | 2.50 | 27.00 | 5.30 | 8.70 |
| PET | 0.00 | 2.50 | 5.40 | 26.50 | 8.60 |
| CELL | 0.00 | 20.20 | 0.00 | 7.10 | 6.83 |
| PVC | 0.00 | 1.00 | 1.00 | 1.00 | 0.75 |

Based on the carbon and hydrogen atoms content of the raw materials used (indicated in the previous table), the carbon index and the H/C index (H/C index) can then be calculated, according to the following formulas:

$$H / C Index = 100 \cdot \frac{12}{2} \cdot \frac{{\sum }_{MATERIALS} Weight of H atoms}{{\sum }_{MATERIALS} Weight of C atoms}$$

$$Carbon Index = 100 \cdot \frac{{\sum }_{MATERIALS} Weight of C atoms}{{\sum }_{MATERIALS} Weight of ALL atoms}$$

where the summation is carried out on each material of which the compound is composed, and where “Weight of atoms” means the total mass of the atom indicated (or of all atoms for “All”) in the material. For the five compounds used, the following H/C index and carbon index values can therefore be calculated from these formulas, while for the recycled material such as Plasmix BAL the calculation was made starting from the atomic composition shown above:

| | MIX | | | | | AS IS |
|---|---|---|---|---|---|---|
| | PAT1 | PAT2 | PAT3 | PAT4 | PAT5 | BA1 |
| H/C index | 100 | 95 | 83 | 83 | 90 | 94 |
| C.I. Carbon Index | 86 | 76 | 86 | 77 | 81 | 79 |
| HIGH H/C (>90) | + | + | − | − | 0 | + |
| Carbon Index | + | − | + | − | 0 | 0 |
| HIGH (>80) | | | | | | |

Analysing the table it is clear that PAT1 and PAT2 are compounds characterised by a high H/C index, PAT3 and PAT4 by a low H/C index; while PAT1 and PAT3 have a high carbon index (both 86) and PAT2 and PAT4 a low carbon index (both 76). The substantially recycled plastics material such as Plasmix “BA1” has instead a high H/C index and an average Carbon Index (about 80).

In this way it is possible to analyse the behaviour of the pyrolysis materials with respect to the two indicated variables (H/C index and carbon index).

The PAT 5 mixture is the average composition of the previous 4 (PAT1, PAT2, PAT3 and PAT4) and was used to validate the model and experiment.

### Pyrolysis Apparatus Used for the Examples (“Apparatus 1”)

The pyrolysis apparatus used for the examples in the present invention consisted of:
a thermostatted reactor, equipped with a flange for loading materials, a dip tube for entry of the inertizing gas (nitrogen), a port (N1) for connection to a possible extruder for the entry of substantially plastics material, a port (N2) for the exit of vapours and an opening (NT1, NT2, NT3, NP) for each of the thermocouples for temperature and pressure measurement, plus two openings (NL1, NL2) for level measurement;
a stirring system for said reactor, equipped with an anchor stirrer, low rotation speed (tip velocity approx. 0.1 m/s) and baffles;
a flow meter equipped with a fine adjustment valve for regulating the rate of inertizing gas flow into the reactor;
a pressure transducer located at the reactor top, plus a local pressure gauge, which read the pressure of the gases inside the reactor;
three thermocouples for measuring the actual temperature located in the lower part of the reactor;
a reactor temperature regulating system that reads the temperature value of one of the three thermocouples and acts through feedback on the thermostatting system, the control parameters of which have been suitably calibrated to ensure high thermal stability (temperature fluctuations below 5° C.);
a level indicator, through the use of a differential pressure sensor which reads the hydrostatic head in the reactor (pressure difference between the top and the bottom of the reactor);
a condenser for condensation of the vapours leaving the reactor, held at −10° C. by means of a cooling fluid made to flow from a refrigeration unit at a controlled temperature;
a valve for regulating the flow of gas leaving the reactor located between said reactor and said condenser;
a reactor pressure regulating system which reads the pressure value of said pressure transducer and acts through feedback on said regulating valve, so as to ensure high pressure stability (pressure oscillations lower than 50 mbar);
an expandable flask hermetically connected to the upper outlet of said condenser intended to collect the gaseous fraction which is not condensed;
a receiving container hermetically connected to the lower outlet of said condenser intended to collect the condensed fraction and therefore in the liquid state, with vents connected to said upper outlet of the condenser;
a valve for interception of the incoming nitrogen;
a valve for interception of the liquid product leaving the condenser, before the sealed connection with the receiving container;
a valve for interception of the gaseous product leaving the condenser, before the sealed connection with the expandable flask;
a twin-screw extruder for dosing the granulated polymer mixture into the reactor from said port for the entry of substantially plastics material;
a gravimetric doser for dosing the granulated polymer mixture into the hopper of said twin screw extruder for dosing the granulated polymer mixture into the reactor.

The positions of the ports for entry of the substantially plastics material, for exit of the vapours and for exit of the solid material are such that, referring to the definitions previously given, D1<H/3, D2<H/3, DJ>D1, DJ>H/3, DS>D1, D3=0 (drain at the bottom). The reactor has a substantially convex and substantially axially symmetrical profile, according to the definitions indicated above, with a hemispherical lower end and a flat upper end.

### Examples of Preparation of the Granulated Polymer Mixture

The compounds (PAT1, PAT2, PAT3, PAT4, PAT5) were prepared as per the composition table shown above. For example, mixture “PAT1” was prepared, comprising the following materials:
42 parts of low density polyethylene (LDPE) type Riblene® FC20 manufactured by Versalis;
24 parts of linear low density polyethylene (LLDPE) type Flexirene® CL10 manufactured by Versalis;
4 parts of high density polyethylene (HDPE) type Eraclene® BC82 manufactured by Versalis;
30 parts of polypropylene (PP) type I SPLEN® PP040 manufactured by Repsol.

In a Coperion ZSK 26 twin-screw extruder, the compounds thus prepared were melted at 250° C., mixed using mixing elements present in the screws of the extruder, and passed through a die. The overall residence time in extrusion was less than one minute. The mixture of polymers thus obtained was then cooled in a liquid bath and granulated into granules with a diameter and length equal to approx. 3 mm. In this way mixtures of the PAT1, PAT2, PAT3, PAT4 and PAT5 granulated polymers were produced.

### Pyrolysis Examples 1 to 8 (Comparative and According to the Invention

Examples 1 to 8 were made with the mixtures of granulated polymers, set-ups, thermal profiles and pressures indicated in the following table (set-up and thermal profile specified further below):

| Example | | | | | | | | | |
|---|---|---|---|---|---|---|---|---|---|
| number | [#] | 1 | 2 | 3 | 4 | 5 | 6 | 7 | 8 |
| Comparative | [−] | Comp. | Inv. | Comp. | Inv. | Comp. | Inv. | Inv. | Comp. |
| Invention | | | | | | | | | |
| Set-up | [#] | A1 | A1 | A1 | A1 | A1 | A1 | A1 | A1 |
| Temp. | [#] | T1 | T1 | T1 | T1 | T1 | T1 | T1 | T1 |
| Profile | | | | | | | | | |
| Polymer | [−] | PAT1 | PAT1 | PAT2 | PAT2 | PAT3 | PAT3 | PAT4 | PAT4 |
| mix | | | | | | | | | |
| Pressure | [bar | Atm. | 5 | Atm. | 5 | Atm. | 5 | Atm. | 5 |
| | (a)] | | | | | | | | |

In the reactor of “Apparatus 1” described above the indicated granulated polymer mixture was charged at room temperature until ⅓ of the geometric volume of the reactor was reached. The port for the possible entry of molten polymer from the extruder was not used and was plugged.

The valve for regulating the flow of gas leaving the reactor was manually set to full opening.

Nitrogen was then injected from below through the dip tube, fully opening the fine adjustment valve of the flow meter.

The gases contained in the reactor were then removed over a time equal to 24 hours, in order to ensure the elimination of oxygen.

The valves on the outlet of the gaseous and liquid products from the condenser were then closed. Immediately afterwards, the nitrogen supply was interrupted. We then proceeded to connect the expandable flask for collecting the gases produced and the receiving container for collecting the liquids produced.

The valves on the outlet of the gaseous and liquid products from the condenser were then reopened.

The valve for regulating the flow of gas leaving the reactor was set for automatic regulation at the value chosen for the test (in this example, 0 barg=1 bar (a)).

Nitrogen was then injected from below through the dip tube, but setting a low flow rate, selected so that the quantity of nitrogen collected in the expandable balloon before its replacement did not exceed 30% of the maximum volume of the balloon.

The modality described above for examples 1-8 will be defined hereinafter as “Set-up A1”.

The reactor thermal-regulation system was turned on, setting the following program:
1. first heating ramp of 4 degrees per minute, until reaching 380° C.;
2. holding the temperature of 380° C. for 3 hours;
3. second heating ramp of 2 degrees per minute, until reaching 430° C.;
4. holding the temperature of 430° C. for 3 hours;
5. third heating ramp of 2 degrees per minute, until reaching 480° C.;
6. holding the temperature of 480° C. for 3 hours;
7. switching off the heating.

The temperature vs time profile described above will hereinafter be described as “Profile T1”.

### Cleaning

After 12 hours from the end of the program, it was checked that the reactor temperature was below 60° C. and the nitrogen supply was interrupted, the valves were closed to intercept the liquid and gaseous product leaving the condenser and open the reactor flange.

The inside of the reactor was carefully cleaned in order that all the dust and deposits that may have formed on the parts that were in contact with the liquid and gas produced fell into it.

### Analyses

We then proceeded to completely remove all the solid material from the bottom of the reactor and to weigh it, and to detach the container for receiving the liquids and the expandable flask.

The liquid contained in the liquid receiving container was weighed and then subjected to ultracentrifuging (Thermo Scientific ultracentrifuge model Sorvall Evolution RC) at 25000 RPM for 45 minutes.

The fraction left on the bottom after ultracentrifuging (hereinafter described as the wax fraction) and the supernatant (hereinafter described as the oil fraction) was then separated and weighed.

The percentage of oil was calculated by dividing the weight of the oil fraction obtained by the weight of the material initially fed into the reactor.

The wax percentage was calculated by dividing the weight of the wax fraction obtained by the weight of the material initially fed into the reactor.

The percentage of carbon residue (char) was calculated by dividing the weight of the solid fraction obtained by the weight of the material initially fed into the reactor.

The mass of gas produced was calculated as the difference between the weight of the material initially fed into the reactor and the sum of the weights of the wax, carbon residue (char) and oil fractions. The gas fraction produced was calculated by dividing the mass of the gas fraction thus calculated by the weight of the material initially fed into the reactor.

The fractions obtained were analysed using the techniques described above. About 130 chemical compounds were identified.

For each of these chemical compounds the number of atoms of each element and, from the atomic mass of each atom, the mass fraction of the atoms were calculated.

By “C5-C12 yield” we mean the sum of the mass of the chemical compounds having from 5 to 12 carbon atoms (extremes included) in the evaporated pyrolysis product with respect to the total mass of said pyrolysis product. Similarly, by “C21+ yield” is meant the sum of the mass of the chemical compounds having at least 21 carbon atoms in the evaporated pyrolysis product with respect to the total mass fed.

By “C5-C12 fraction” we mean the sum of the mass of chemical compounds having from 5 to 12 carbon atoms (extremes included) in a product with respect to the total mass of the same. Similarly, by “C21+ fraction” is meant the sum of the mass of chemical compounds having at least 21 carbon atoms in a product with respect to the total mass of the same.

By evaporated pyrolysis product we therefore mean the sum of the gas fraction, oil fraction and wax fraction, but not residual solid (char).

For this purpose, the gas chromatographic analysis was carried out separately on each of the gas, oil and wax fractions, then calculating the yield of a given compound “C” as follows:

$${x}_{C , VAP} = {f}_{GAS} \cdot {x}_{C , GAS} + {f}_{OIL} \cdot {x}_{C , OIL} + {f}_{WAX} \cdot {x}_{C , WAX}$$

where:
x_{C, <FRAC>} is the mass fraction of compound C in the product fraction <FRAC> indicated (<FRAC> is GAS=gaseous fraction, OIL=oil fraction or WAX=wax fraction). In the case of the GAS fraction, the nitrogen fraction present was previously eliminated from the calculation (this being fed as an inert gas and not a pyrolysis product). The chromatogram of the GAS fraction gives the parts by volume that have been converted into parts by weight assuming that the parts by volume correspond to the parts in moles and then calculating the parts by weight knowing the molecular weights of the compounds.
f_{OIL} and f_{WAX} are the mass fractions of the oil and wax fractions respectively, obtained by dividing the weight of the collected material by the weight of the material fed to pyrolysis. The weight of the gas produced was on the other hand calculated using the difference between the weight of the material fed to pyrolysis and the sum of the weights of the materials of the oil, wax and solid residue (char) fractions:

$${M}_{GAS} = {M}_{FEED} - ( {M}_{CHAR} + {M}_{OIL} + {M}_{WAX} )$$

f_{GAS} it was instead calculated from the ratio between MGAS and M_{FEED}.

### Examples of Pyrolyses 9 to 11

Examples 9, 10 and 11 were carried out under the same set-up and thermal profile conditions as in examples 1-8 (set-up A1 and temperature profile T1). The pressure was set at 3 bar (a). In fact, the aim was to evaluate the repeatability, and therefore the reliability, of the results obtained, and as is the practice often followed in the design of experiments (DOE, design of experiments) it was decided to repeat the central point 3 times.

The mixture used for all three Examples was PAT5, which as previously reported has a composition which is the average of compositions PAT1, PAT2, PAT3 and PAT4. The mixture was extruded forming a granulated polymer as per examples 1 to 8.

### Pyrolysis Examples 12 to 13 (Comparative and According to the Invention

The examples according to the invention and the comparative examples (Examples 1 and 2) carried out using PAT1 polymer mixture, pyrolysis pressure 1 and 5 bar (a), were repeated, but using a different thermal profile just described.

The following was set on the reactor thermal regulation system:
1. heating ramp of 4 degrees per minute, until reaching 430° C.;
2. holding the temperature of 430° C. for 6 hours;
3. switching off the heating.

The difference with respect to the previous examples is therefore that the duration of the pyrolysis treatment was reduced from 9 to 6 hours (plus ramp time), and by choosing the intermediate stage temperature at 430° C. as the treatment temperature.

The temperature profile thus modified will hereinafter be described as “Profile 12”. The two different temperature profiles T1 and T2 are illustrated in the graph in FIG. 7.

In Examples 12 and 13 the PAT1 polymer mixture was treated. The set pressure was atmospheric pressure for example 12 and 5 bar (a) for example 13.

### Examples of Pyrolysis 14 to 17 (According to the Invention

These examples refer to the pyrolysis plant managed in semi-continuous mode, and according to the “A2” set-up better specified below.

The port of “Apparatus 1” for the possible entry of polymer from the extruder was opened and connected to a twin-screw extruder. The substantially plastics material was not initially loaded into the reactor, as done in Examples 1-13 previously illustrated, but into the hopper of the gravimetric metering unit which feeds the extruder. The speed of the extruder screw was adjusted to ensure that the extruder hopper remained empty (“hungry mouth”). The flow rate of the gravimetric doser was adjusted so that the reactor level, maintained at 430° C., was equal to 40% of the total volume of the reactor. The volumetric flow rate of the polymer leaving the extruder was calculated by dividing the mass flow rate set on the dispenser by the density of the melted polymer. Before starting to feed the substantially plastics material, the atmosphere of the pyrolysis reactor was inertized by the entry of nitrogen as an inert gas, as done in the previous examples. The valve for regulating the flow of gas leaving the reactor was set for automatic regulation at the value chosen for the test, as already done in the previous examples. A time of 6 hours was allowed for stabilising the reaction and the adjustments, during which the nitrogen inlet was closed. Once the stabilisation time was over, the residence time was measured, calculated by dividing said flow rate by the density of the substantially plastics material fed in the molten state and by the volume used in the reactor (40% of the total, as mentioned), which was equal about 6.3 hours. Unlike the batch examples, it is not possible to evaluate the mass of the solid residue until the end of the test, as the examples were carried out in succession without opening the reactor between one example and the next. The mass of the non-condensed vapours was therefore evaluated on the basis of the volume of the expandable balloon and the density of the gas calculated on the basis of the compositional analysis of the gases present in it. The mass of the residual solid in the reactor was then calculated as the difference between the mass of substantially plastics material fed and the sum of the mass of the collected pyrolysis oil and mass of gas thus evaluated:

$${M}_{CHAR} = {M}_{FEED} - ( {M}_{GAS} + {M}_{OIL} + {M}_{WAX} )$$

Example 14 was carried out using “PAT2” mixture as the substantially plastics material, for a further 2 hours after the first hours of stabilisation (performed with the same mixture), at the pressure indicated in the table, and collecting the pyrolysis products as per the previous examples.

Immediately afterwards, without interrupting the pyrolysis, the material present in the hopper of the gravimetric doser was replaced with substantially recycled plastics material such as Plasmix “BA1” and the pyrolysis pressure set point was adjusted as per the table. Six hours were allowed for exchange of the material in the reactor, then the representative samples for the test were taken (Example 17) in the next 2 hours.

The pyrolysis pressure set point was then changed to atmospheric pressure (as per table). Six hours were allowed, then the representative samples for the test (Example 18) were taken in the next two hours.

The pyrolysis pressure set point was then changed to atmospheric pressure (as per table). Six hours were allowed, then the representative samples for the test (Example 19) were taken in the next two hours.

Feeding of the substantially plastics material was interrupted, keeping the temperature in the reactor unchanged in order to complete the pyrolysis of what was present in the reactor, until the production of condensate was no longer observed. The reactor was then left to cool, reactivating the nitrogen flow, finally it was depressurised and opened. No fouling was observed.

Finally, it was observed that the pyrolysis process was regular. The change in the substantially plastics material fed (which took place between tests 16 and 17) and the changes in the setting (set point) for the pyrolysis pressure (which took place in the setting of tests 16, 17, 18) did not destabilise the automatic adjustments. The condensed product did not show the presence of polymer or solid residue, which would have been present in case of foaming and consequent entrainment.

### Results

The tables below show the C5-C12 yield, the C21+ yield and the overall quality of the product achieved (“+” if simultaneously C5-C12 yield ≥30% and C21+ yield ≤3%) as a function of the H/C index, of the carbon index, and the overall index (overall index, given by the H/C index product by the carbon index divided by 10000):

| Example | | | | | | | | | |
|---|---|---|---|---|---|---|---|---|---|
| number | [#] | 1 | 2 | 3 | 4 | 5 | 6 | 7 | 8 |
| Comparative/ | [−] | Comp. | Inv. | Comp. | Inv. | Comp. | Inv. | Inv. | Comp. |
| Invention | | | | | | | | | |
| Set-up | [#] | A1 | A1 | A1 | A1 | A1 | A1 | A1 | A1 |
| Temp. Profile | [#] | T1 | T1 | T1 | T1 | T1 | T1 | T1 | T1 |
| Polymer | [−] | PAT1 | PAT1 | PAT2 | PAT2 | PAT3 | PAT3 | PAT4 | PAT4 |
| mix | | | | | | | | | |
| Pressure | [bar (a)] | Atm. | 5 | Atm. | 5 | Atm. | 5 | Atm. | 5 |
| H/C index | [0-100] | 100 | 100 | 95 | 95 | 83 | 83 | 83 | 83 |
| C.I. Carbon | [0-100] | 86 | 86 | 76 | 76 | 86 | 86 | 77 | 77 |
| Index | | | | | | | | | |
| Overall | [0-1] | 0.86 | 0.86 | 0.72 | 0.72 | 0.71 | 0.71 | 0.64 | 0.64 |
| index | | | | | | | | | |
| Yield C5-C12 | [wt. %] | 36% | 61% | 34% | 49% | 47% | 58% | 33% | 32% |
| Yield C21+ | [wt. %] | 3.70% | 0.24% | 22.30% | 2.08% | 3.80% | 0.72% | 2.90% | 10.10% |
| THF | [wt. %] | 0.025% | 0.08% | 0.04% | 0.11% | 0.02% | 0.07% | 0.07% | 0.06% |
| Benzoic | [wt. %] | 0.03% | 0.00% | 0.42% | 0.08% | 1.30% | 1.00% | 2.00% | 2.10% |
| acid | | | | | | | | | |
| Isobutene | [wt. %] | 0.77% | 0.32% | 0.34% | 0.20% | 0.25% | 0.22% | 0.18% | 0.37% |
| Product | [+/−] | − | + | − | + | − | + | + | − |
| quality | | | | | | | | | |

| Example | | | | | | |
|---|---|---|---|---|---|---|
| number | [#] | 9 | 10 | 11 | 12 | 13 |
| Comparative/ | [−] | Inv. | Inv. | Inv. | Comp. | Inv. |
| Invention | | | | | | |
| Set-up | [#] | A1 | A1 | A1 | A1 | A1 |
| Temp. Profile | [#] | T1 | T1 | T1 | T2 | T2 |
| Polymer | [−] | PAT5 | PAT5 | PAT5 | PAT1 | PAT1 |
| mix | | | | | | |
| Pressure | [bar (a)] | 3 | 3 | 3 | Atm. | 5 |
| H/C index | [0-100] | 90 | 90 | 90 | 100 | 100 |
| C.I. Carbon | [0-100] | 81 | 81 | 81 | 86 | 86 |
| Index | | | | | | |
| Overall | [0-1] | 0.73 | 0.73 | 0.73 | 0.86 | 0.86 |
| index | | | | | | |
| Yield C5-C12 | [wt. %] | 47% | 49% | 48% | 44% | 56% |
| Yield C21+ | [wt. %] | 2.61% | 2.72% | 2.80% | 3.22% | 1.20% |
| THE | [wt. %] | 0.05% | 0.05% | 0.04% | n.d. | n.d. |
| Benzoic acid | [wt. %] | 1.00% | 1.05% | 0.90% | n.d. | n.d. |
| Isobutene | [wt. %] | 0.28% | 0.26% | 0.27% | n.d. | n.d. |
| Product | [+/−] | + | + | + | − | + |
| quality | | | | | | |

| Example | | | | | |
|---|---|---|---|---|---|
| number | [#] | 14 | 15 | 16 | 17 |
| Comparative/ | [−] | Inv. | Inv. | Comp. | Inv. |
| Invention | | | | | |
| Set-up | [#] | A2 | A2 | A2 | A2 |
| Temp. Profile | [#] | T2 | T2 | T2 | T2 |
| Polymer mix | [−] | PAT2 | BA1 | BA1 | BA1 |
| Pressure | [bar (a)] | 5 | 4 | Atm. | 4 |
| H/C index | [0-100] | 95.2 | 94 | 94 | 94 |
| C.I. Carbon | [0-100] | 76 | 79 | 79 | 79 |
| Index | | | | | |
| Overall index | [0−1] | 0.72 | 0.74 | 0.74 | 0.74 |
| Yield C5-C12 | [wt. %] | 50.0% | 53.0% | 27.8% | 54.0% |
| Yield C21+ | [wt. %] | 2.50% | 1.50% | 9.30% | 1.10% |
| THF | [wt. %] | n.d. | n.d. | n.d. | n.d. |
| Benzoic acid | [wt. %] | n.d. | n.d. | n.d. | n.d. |
| Isobutene | [wt. %] | n.d. | n.d. | n.d. | n.d. |
| Product | [+/−] | + | + | − | + |
| quality | | | | | |

### Discussion of the Results

One of the objects of the invention is to solve the criticalities linked to the pyrolysis of substantially plastics material which varies greatly in composition (and which is therefore substantially inconstant), while maintaining high quality of the pyrolysis products.

Mixtures PAT1, PAT2, PAT3 and PAT4 were therefore chosen to evaluate the most suitable pyrolysis conditions when the incoming raw material undergoes large changes:
PAT1 is made up exclusively of vinyl polymers (polythene and polypropylene);
PAT2 includes a large amount of cellulose (20.2%)
PAT3 contains a large amount of polystyrene (27%)
PAT4 contains a large amount of polyethylene terephthalate (PET) (26.5%).

The experiments performed show that there is no process condition which is optimal with respect to said objective of the present invention for all the compositions of incoming raw materials.

In particular, it is very clear that where there is a high H/C index and a high Carbon Index it is very advantageous to carry out pyrolysis at higher than atmospheric pressure: in Example 2 conducted at 5 bar (a) compared to Example 1 (comparative) conducted at atmospheric pressure the yield in C5-C12 is almost doubled, and the share of yields of undesired fractions C21 or higher (C21+) is also drastically reduced from 3.7% to 0.24%.

Comparative Example 3 and Example 4 according to the invention show the effect of pressure when a raw material with an H/C index similar to Examples 1 and 2 but with a reduced Carbon Index (from 86 to 76) is used. Also in this case there is a significant advantage in operating pyrolysis at high pressure, even if the advantage is reduced (C5-C12 yield goes from 34% to 49%, while the undesired C21+ yield drops from 22.3% to 2.1%).

Comparative Example 5 and Example 6 according to the invention show the effect of pressure when a raw material is used with carbon index substantially the same as in Examples 1 and 2 (86 in both cases) but with a significant reduction in the H/C index (100 to 83). Also in this case there is a significant advantage in operating pyrolysis at high pressure, even if the advantage is reduced (C5-C12 yield goes from 47% to 58% while the undesired C21+ yield drops from 3.8% to 0.7%).

Comparative Example 7 and Example 8 according to the invention show the effect of pressure when using a raw material with a carbon index substantially the same as the low value used in Examples 3 and 4 (77, very close to the value of 76 in Examples 3 and 4) and with an H/C index which is substantially the same as the low value used in Examples 5 and 6 (83 in both cases). Surprisingly, in this case there was no advantage in increasing the pyrolysis pressure: the C5-C12 yield remained substantially constant (although reduced from 33% to 32%). However it is very important to note that the C21+ yield rose tremendously, from 2.9% to over 10%.

It is therefore evident that while for some raw material mixtures it is advantageous to operate at high pressure, for other raw material mixtures it is advantageous not to operate at high pressure.

Furthermore, even with respect to the preferred object of obtaining a C5-C12 yield of at least 30%, even more preferably at least 40%, and at the same time a C21 and higher yield (C21+) of at most 3%, it is clear that use of the high pressure system only makes it possible to achieve this object under some conditions (PAT1, PAT2, PAT3), while for others (PAT4) it is convenient to keep the system at a lower pressure.

From this evidence, which the Applicant has been the first to notice, there is an opportunity to adjust the process conditions according to the composition of the substantially plastics material fed. Since, as previously mentioned, this composition can vary in the course of the process (especially when it is carried out in semi-continuous or continuous mode), the process according to the present invention advantageously makes it possible to adjust the pressure during the pyrolysis stage, and is therefore able to maximise the result when the raw material entering pyrolysis varies; preferably, the process according to the invention is also capable of achieving the preferred object of obtaining a C5-C12 yield of at least 30%, more preferably at least 40%, and at the same time a C21 and higher yield (C21+) of at most 3%, by suitably adjusting the pyrolysis pressure according to the composition of the plastics material fed.

Compared to the even more preferred mode in which the pyrolysis process is carried out at a pressure equal to at least a threshold pressure PS when the Overall Index (equal to the C.I. index multiplied by the H/C index divided by 10000) is 0.7 or above, and at a pressure lower than said threshold pressure PS when the Overall Index is below 0.7, it should be noted that the use of this criterion has made it possible to obtain the production of a product that maximises the C5-C12 yield, at the same time minimising the C21+ yield, in particular for values of said threshold pressure PS between 2.0 and 2.9 bar (a).

In fact, by applying this criterion in Examples 1 to 11 of the patent, a C5-C12 yield of at least 30%, and at the same time a C21 and higher yield (C21+) of at most 3%, was obtained. Furthermore, the C21+ fraction in the pyrolysis oil obtained was no more than 3.5%, while the C5-C12 fraction in the pyrolysis oil was at least 35%.

The process according to the present invention has proved to be very repeatable, as shown in Examples 9 to 11.

Examples 12 and 13 also show that similar results conforming to the teachings of the present invention can also be obtained by using different thermal profiles.

Surprisingly, the process according to the present invention has made it possible to carry out the pyrolysis of substantially plastics material having very high quantities of polymers/materials with a low carbon content, with a carbon index even lower than 80, and with a high oxygen content, in particular a substantially plastics material with over 20% cellulose, without manifesting operating or fouling problems, and with a high C5-C12 yield and a reduced C21 and higher yield, in both batch mode (Example 4) and semi-continuous mode (Example 14).

Examples 15, 16 and 17 also show that the invention is very effective even for substantially plastics materials which are the residue after sorting of the Plasmix type. In fact, the O.I. index is greater than 0.7 and the yield of the C5-C12 fraction increases greatly when the pressure is increased. Furthermore, the undesired C21+ yield also drops significantly with increasing pressure.

Examples 14, 15, 16 and 17 also show that the semi-continuous process is able to handle both variations in the composition of the substantially plastics material fed, and variations in pressure, without causing fouling or changes in the process such as to bring about the entrainment of polymer and/or solid residues such as fouling.

As can be seen from the comparison between the Examples and the Comparative Examples, the pyrolysis carried out at 5 bar (a) resulted in a significant increase in the tetrahydrofuran (THF) content of the liquid hydrocarbons produced in comparison with the same tests carried out at ambient pressure (increase from 175% to 250%), where the substantially plastics material is characterised by an “Overall index” O.I. of 0.7 or above.

Likewise, the tests carried out starting with substantially plastics material having an Overall Index above 0.7 have a reduced benzoic acid content. In the case of Example 2 compared to Example 1 (PAT1 mixtures), no benzoic acid was found (100% reduction). Important reductions were also obtained with Example 4 in comparison with Example 3 (tests which used PAT2 as a mixture), where the reduction was greater than 80%. The reduction in the case of Example 6 with respect to Example 5 (PAT3 mixture) was smaller, but still significant (−23%).

In the same Examples, by comparison with the respective Comparative Examples, it can be seen that the quantity of isobutene has also been significantly reduced, thus also improving the quality of the naphtha obtained.

It should also be noted that the best results from the process according to the present invention are obtained with a plastics material having a low polyolefin content, that is the material that is normally discarded by the sorting process for the recovery of homoplastics materials.

1. A Process for the pyrolysis of substantially plastics material to obtain at least liquid hydrocarbons that are in the liquid state at 25° C. comprising the following steps:
a) feeding the substantially plastics material optionally already in the molten and/or preheated state to a pyrolysis reactor;
b) bringing said material in said pyrolysis reactor to a temperature of between 330° C. and 580° C. in the substantial absence of oxygen and at a pressure of between atmospheric pressure and 13 bar (a);
c) holding said material in said pyrolysis reactor at a temperature of between 330° C. and 580° C. for a time sufficient to produce at least one effluent in the gaseous state in said pyrolysis reactor;
d) adjusting the pressure in said pyrolysis reactor in relation to characteristic parameters defined by the composition of said substantially plastics material and/or characteristic parameters defined by the products of said pyrolysis process, while maintaining said pressure at a value between atmospheric pressure and 13 bar (a);
e) partly or totally condensing said effluent in the gaseous state so as to form at least one fluid comprising liquid hydrocarbons that are in the liquid state at 25° C. which quantitatively is at least 10% by mass with respect to the mass of substantially plastics material fed.

2. The process for pyrolysis of substantially plastics material according to claim 1, in which said characteristic parameters defined by the products of said pyrolysis process are the yield in the production thereof and/or a characteristic measured thereon.

3. The process for the pyrolysis of substantially plastics material according to claim 1 or 2, in which said substantially plastics material fed has an inconstant composition.

4. The process for the pyrolysis of substantially plastics material according to claim 1, in which said pressure is temporally not constant.

5. The process for the pyrolysis of substantially plastics material according to claim 1, in which said pressure is spatially not constant.

6. The process for the pyrolysis of substantially plastics material according to claim 1, in which the time sufficient to produce at least one effluent in the gaseous state in said pyrolysis reactor is at least 30 minutes.

7. The process for the pyrolysis of substantially plastics material according to claim 6, in which the sufficient time to produce at least one effluent in the gaseous state in said pyrolysis reactor is between 1.5 hours and 9 hours.

8. The process for the pyrolysis of substantially plastics material according to claim 1, said process being incorporated downstream of a process for the recovery of plastics material which includes a sorting plant and in which said pyrolysis process uses, as the substantially plastics material fed in step a), the fraction not recovered as a single polymer.

9. The process for the pyrolysis of substantially plastics material according to claim 1, in which said substantially plastics material comprises plastics material and an amount of between 0.01 and 10% of non-plastics material.

10. The process for the pyrolysis of substantially plastics material according to claim 1, which further comprises the following step:
c2) bringing the effluent in the gaseous state produced in step c) to a temperature between 40° and 650° C. and holding said effluent within said temperature range for a time of at least 10 seconds, preferably between 30 seconds and 6 minutes, even more preferably between 1 and 4 minutes.

11. The process for the pyrolysis of substantially plastics material according to claim 1, comprising the following step:
f) recycling in said pyrolysis reactor some of the fluid in the liquid state comprising liquid hydrocarbons that are in the liquid state at 25° C. condensed in step e).

12. Process for the pyrolysis of substantially plastics material according to claim 1, comprising the step of feeding an auxiliary gaseous fluid to the pyrolysis reactor, or to an apparatus in fluid connection therewith preferably at a mass flow rate from 1% to 50% of the pyrolysis vapours flow rate, or from 2% to 30% of the pyrolysis vapours flow rate, or from 3% to 20% of the pyrolysis vapours flow rate.

13. The process for the pyrolysis of substantially plastics material according to claim 12, in which said auxiliary gaseous fluid is selected from the group consisting of a nitrogen, carbon dioxide, argon, natural gas, light hydrocarbons, methane, C1-C2, C1-C2-C3 or C1-C2-C3-C4 mixtures, some of the gas obtained after passage of the pyrolysis vapours through at least one condensation separator, water vapour and mixtures thereof.

14. The process for the pyrolysis of substantially plastics material according to claim 1, in which the pressure in the pyrolysis reactor in step d) is regulated in one or more of the following ways:
regulation of the heat extracted from the condensation separator located downstream of the reactor and in fluid connection therewith, preferably by regulating the power of the condensation separator;
when an auxiliary gaseous fluid is supplied, adjusting the flow rate of said auxiliary gaseous fluid;
control of pressure regulation of the pyrolysis vapours by adjusting the opening of a valve through which the pyrolysis vapours pass before entering at least one condensation separator;
control of pressure regulation of the residual gas by adjusting the opening of a valve through which passes the residual gas consisting of the fluid comprising hydrocarbons which has not been condensed after passing through at least one condensation separator;
double control of pressure regulation by combination of the control mode for pressure regulation of the pyrolysis vapour and the control mode for pressure regulation of the residual gas.

15. The process for the pyrolysis of substantially plastics material according to claim 1, in which said characteristic parameters defined by the composition of said substantially plastics material are the H/C index (H/C index) and/or the carbon index of said substantially plastics material.

16. The process for the pyrolysis of substantially plastics material according to claim 1, in which the pyrolysis process is carried out at a pressure of at least the threshold pressure PS when the “Overall index” O.I. is greater than or equal to 0.7, and at a pressure lower than said threshold pressure PS when O.I. is less than 0.7, said threshold pressure PS being at least 1.5 bar (a), preferably between 2 and 2.9 bar (a), more preferably 2.5 bar (a), and in which said “Overall index” O.I. is defined as the carbon index (C.I.) multiplied by the H/C index divided by 10000:
$$O . I . = \frac{[ C . I . ] \cdot [ H / C idx ]}{10000}$$
in which the H/C index (“H/C index”) is proportional to the ratio of the total mass of hydrogen atoms to the total mass of carbon atoms present in the substantially plastics material, and is calculated using the following formula:
$$H / C Index = 100 \cdot \frac{12}{2} \cdot \frac{Weight H atoms}{Weight C atoms}$$
where “Weight of H atoms” corresponds to the total weight of all hydrogen atoms and “Weight of C atoms” to the total weight of all carbon atoms and in which the carbon index is proportional to the ratio between the total mass of carbon atoms with respect to the total mass of all atoms present in the substantially plastics material, and is calculated using the following formula:
$$Carbon Index = 100 \cdot \frac{Weight C atoms}{Weight ALL atoms}$$
where “Weight of ALL atoms” corresponds to the weight of the substantially plastics material.

17. The process for the pyrolysis of substantially plastics material according to claim 1, the process being characterized in that the pressure regulation of step d) has low latency, where low latency means that the latency is not higher than 600 seconds, preferably not higher than 100 seconds, and where latency means the time delay from the beginning of the measurement of the characteristic parameter evaluated the substantially plastics material fed and/or of the characteristic parameter evaluated on the pyrolysis oil produced by said reactor to the moment in which the pressure set-point is set.

18. The process for the pyrolysis of substantially plastics material according to claim 17, wherein in step d) said characteristic parameters defined by the composition of said substantially plastic material and/or said characteristic parameters defined by the products of said pyrolysis process are measured with at least one of the following measurement methods:
UV-Vis absorption spectroscopy
Fluorescence emission spectroscopy
X-ray fluorescence emission spectroscopy (XRF)
X-ray dispersion spectroscopy (EDX)
Fourier transform mid-infrared absorption spectroscopy (FTIR)
Fourier transform near infrared absorption spectroscopy (FT-NIR)
Raman absorption spectroscopy
Rotovibrational microwave spectroscopy
Dynamic light scattering (DLS)
Circular dichroism
Photoacoustic spectroscopy
Ultrafast laser spectroscopy
Laser-induced Breakdown Spectroscopy (LIBS).

19. An apparatus specifically designed for the pyrolysis of substantially plastics material to obtain at least liquid hydrocarbons that are in the liquid state at 25° C. as outlined in claim 1, comprising:
at least one reactor for the pyrolysis of substantially plastics material
at least a condensation separator of the vapours produced in said reactor
at least one system for regulating the pressure reactor in relation to one or more characteristic parameters of the substantially plastics material fed and/or one or more characteristic parameters of the pyrolysis oil produced by said reactor.

20. The apparatus for pyrolysis of substantially plastics material to obtain at least hydrocarbons that are in the liquid state at 25° C. according to claim 19, where said system regulating the pressure in said reactor operates according to one or more of the following methods:
regulation of the heat extracted from the condensation separator located downstream of the reactor and in fluid connection therewith, preferably by regulating the power of the condensation separator;
when an auxiliary gaseous fluid is supplied, adjusting the flow rate of said auxiliary gaseous fluid;
control of pressure regulation of the pyrolysis vapours by adjusting the opening of a valve through which the pyrolysis vapours pass before entering at least one condensation separator;
control of pressure regulation of the residual gas by adjusting the opening of a valve through which passes the residual gas consisting of the fluid comprising hydrocarbons which has not been condensed after passing through at least one condensation separator;
double control of pressure regulation by combination of the control mode for pressure regulation of the pyrolysis vapour and the control mode for pressure regulation of the residual gas.

21. The apparatus for pyrolysis of substantially plastics material to obtain at least liquid hydrocarbons that are in the liquid state at 25° C. according to claim 20, which further comprises at least one uncondensed vapour pressure regulation valve located downstream of said condensation separator, where said pressure regulating system for said reactor is in split-range mode and also acts on said uncondensed gas pressure regulation valve.

22. A reactor specifically designed for the pyrolysis of substantially plastics material to obtain at least liquid hydrocarbons that are in the liquid state at 25° C. as outlined in claim 1, comprising:
i) at least one port for exit of the gaseous product located on the top of the reactor or at a distance from the top of the reactor not greater than ⅓ of the height of the reactor;
ii) at least one port for extraction of the solid product located at the bottom of the reactor or at a distance from the bottom of the reactor not greater than ⅓ of the height of the reactor;
iii) at least one port for entry of substantially plastics material at a distance from the top of the reactor that is equal to or greater than the distance between said port for exit of the gaseous product and the top of the reactor;
iv) at least one stirrer;
v) at least one jacket for heating the reactor, in which the height corresponding to the distance of the highest point of the reactor body heated by the jacket from the top of the reactor is equal to or greater than the distance between the port for the entry of substantially plastics material and the top of the reactor;
vi) at least one opening for inserting a temperature transducer;
vii) at least one opening for inserting pressure transducer;
viii) at least one opening for inserting a sensor for measuring the reactor level;
characterised by the presence of a separator for carried over material (demister) placed under and/or at said port for exit of the gaseous product.

23. The reactor for the pyrolysis of substantially plastics material to obtain at least liquid hydrocarbons that are in the liquid state at 25° C. according to claim 22, in which said stirrer (12) comprises stirring elements placed at a distance (DS) from the top of the reactor equal to or greater than the distance (D1) between the port for entry of the substantially plastics material and the top of the reactor.

24. The reactor for the pyrolysis of substantially plastics material to obtain at least liquid hydrocarbons that are in the liquid state at 25° C. according to claim 22, further comprising:
ix) at least one port for entry of an auxiliary gaseous fluid at a distance from the top of the reactor not greater than ⅓ of the height of the reactor and/or
x) at least one port for entry of a liquid fluid condensed in at least one condensation separator and recycled in the reactor, located at a distance from the top of the reactor not greater than ⅓ of the height of the reactor.

25. The reactor for the pyrolysis of substantially plastics material to obtain at least liquid hydrocarbons that are in the liquid state at 25° C. according to claim 22, characterised by a substantially axially symmetrical body, the body of which is preferably formed by a shell composed of three parts rigidly connected at the extremities, of which one said central body, preferably having a cylindrical and/or tapering profile, plus an upper end and a lower end, in which said lower end is of the pseudo-elliptical, elliptical or hemispherical type and said upper end is of the flat, pseudo-elliptical, elliptical or hemispherical type.

26. The reactor for the pyrolysis of substantially plastics material to obtain at least liquid hydrocarbons that are in the liquid state at 25° C. according to claim 22, in which said separator for carried over material (demister) preferably consists of a cyclone characterised by being internal to the reactor and having the gas outlet connected to said port for the exit of gas.

27. The reactor for the pyrolysis of substantially plastics material to obtain at least liquid hydrocarbons that are in the liquid state at 25° C. according to claim 22, in which said jacket for heating the reactor is at a minimum distance from the top of the reactor that is greater than ⅓ of the height of the reactor.

28. The reactor for the pyrolysis of substantially plastics material to obtain at least liquid hydrocarbons that are in the liquid state at 25° C. according to claim 22, said reactor being characterised by a design pressure of at least 3 bar absolute, preferably at least 4 bar absolute, even more preferably at least 6 bar absolute, and a design temperature of at least 330° C., preferably at least 380° C., even more preferably at least 430° C., most preferably at least 480° C., and furthermore characterised by a concave volume equal to at most 10% of the total reactor volume.

29. The reactor for the pyrolysis of substantially plastic material to obtain at least hydrocarbons which are in the liquid state at 25° C. according to claim 22, wherein said reactor comprises at least one system for regulating the pressure in said reactor in relation to one or more characteristic parameters of the substantially plastics material fed and/or one or more characteristic parameters of the pyrolysis oil produced by said reactor, wherein said system for regulating the pressure is characterized by a reduced latency.

30. A mixture obtained by the process according to claim 1, wherein said mixture comprises hydrocarbons in quantities greater than 90% by weight and tetrahydrofuran in quantities between 0.01% and 0.25% by weight, even more preferably between 0.07% and 0.19% by weight, with respect to the total weight of the mixture, preferably comprising a benzoic acid content not higher than 2%, even more preferably between 0.01 and 1%, with respect to the total weight of the mixture, and/or preferably comprising an isobutene content not higher than 0.55%, even more preferably between 0.15 and 0.3%, with respect to the total weight of the mixture.

31. A method for feeding a cracking plant, comprising feeding a mixture according to claim 30.
